(19) United States
(12) Patent Application Publication
(10) Pub. No.: US 2026/0300366 A1
(43) Pub. Date: Oct. 1, 2026

(54) SYSTEMS AND METHODS FOR CROSS-CARRIER LIFE INSURANCE POLICY DISCOVERY AND AUTOMATED DATA STANDARDIZATION

(71) Applicant: Donato B. Guajardo, III, Del Rio, TX (US)

(72) Inventor: Donato B. Guajardo, III, Del Rio, TX (US)

(21) Appl. No.: 19/578,193

(22) Filed: Mar. 25, 2026

Related U.S. Application Data
(60) Provisional application No. 63/779,618, filed on Mar. 28, 2025.

(51) Int. Cl. G06F 16/34; G06Q 40/08; H04L 9/40

(52) U.S. Cl. CPC G06F 16/345; G06Q 40/08; H04L 63/0428; H04L 63/08; H04L 2463/082

(57) ABSTRACT

A computer-based system enables funeral home providers and private citizens to search for life insurance policies associated with deceased individuals through a centralized web-based platform. The system connects to an external insurance industry database that aggregates policy information from multiple insurance carriers. A database access module authenticates users through multi-factor authentication and role-based access control before establishing secure connections with the external database. A query generation module validates, encrypts, and formats user-provided identifying information for transmission. A data retrieval module receives and verifies response data containing policy details from multiple carriers. A result processing module applies a standardization algorithm to normalize varying data formats and naming conventions across different insurers and generates a structured report. The system logs all transactions in an auditable database for regulatory compliance and transmits reports and notifications to authorized users through the web-based interface.

### CROSS-REFERENCE TO RELATED APPLICATIONS

The present application claims priority to U.S. Provisional Application No. 63/779,618 filed Mar. 28, 2025, titled “COMPUTER-BASED LIFE INSURANCE LOCATOR APPLICATION,” which is hereby incorporated by reference in its entirety.

### TECHNICAL FIELD

The embodiments generally relate to the technical field of computer-based systems and methods for locating life insurance policies. More specifically, the disclosed system provides a web-based application that enables funeral home providers and private citizens to access an existing insurance industry database to search for active life insurance policies associated with a deceased individual, streamlining the process of identifying policy details such as the insurer, policy number, face amount, and beneficiary contact information.

### BACKGROUND

The process of locating life insurance policies for a deceased individual has traditionally been inefficient and fragmented. Family members, beneficiaries, or funeral home providers often struggle to determine whether a policy exists and, if so, which insurance company issued it. Conventional methods typically involve contacting multiple insurance companies individually through phone calls, emails, or internal database searches, each of which can be time-consuming and prone to errors or incomplete results. Without a centralized system to search for active policies, beneficiaries may remain unaware of unclaimed life insurance proceeds, leading to unnecessary financial burdens and policy funds being escheated to the state after a statutory period.

Some industry efforts have attempted to simplify the process, such as policy locator services operated by individual insurance companies or industry groups. However, these services often require users to submit requests manually, wait for responses, and navigate multiple platforms with different procedures and requirements. Furthermore, such services may not grant direct access to policy details, instead requiring intermediaries to verify claims, leading to further delays. Additionally, due to the proprietary nature of insurance company databases, previous solutions have lacked a unified, standardized approach for retrieving policyholder information across different insurers.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

In one aspect, the disclosed system, method, or software product may include a database access module configured to establish and manage secure connections between the system and an external life insurance database, such as the Medical Information Bureau (MIB) database. The database access module may authenticate users using multi-factor authentication (MFA) and role-based access control (RBAC) before allowing queries to be executed, ensuring that only authorized individuals such as funeral home providers or verified beneficiaries can access policy-related information across multiple insurance carriers.

In one aspect, embodiments may include a query generation module configured to construct, format, and transmit search queries to the external life insurance database based on user-provided identifying information such as the deceased individual's full name, date of birth, and Social Security number. The query generation module may apply encryption techniques to transmitted data to ensure compliance with data protection regulations such as HIPAA, and may implement error-checking mechanisms to validate the accuracy and completeness of user input before transmitting the query. In some embodiments, the query generation module may dynamically refine subsequent queries when partial matches or incomplete records are returned to improve search accuracy and reduce false positives.

In one aspect, embodiments may include a data retrieval module configured to receive and process responses from the external life insurance database containing life insurance policy information associated with a deceased individual. The data retrieval module may verify that returned data matches original query parameters, filter results based on predefined criteria such as policy status, claim eligibility, or insurer-specific requirements, and trigger additional queries via the query generation module when inconsistencies or incomplete records are detected.

In one aspect, embodiments may include a result processing module configured to format, standardize, and prepare retrieved life insurance policy data for display and reporting. The result processing module may apply a standardization algorithm to normalize data formats and naming conventions received from multiple insurance providers, enabling uniform presentation of policy details including the insurance company name, policy number, face amount, policy status, and beneficiary contact information regardless of the varying data formats used by different insurance carriers.

In one aspect, embodiments may include a communication module configured to securely transmit generated reports to authorized users via a web-based interface. The communication module may implement multi-factor authentication before granting access to reports and may provide an application programming interface (API) that allows third-party funeral service providers to integrate the life insurance lookup functionality into their existing management systems.

In one aspect, embodiments may include a notification module configured to alert users upon successful retrieval of life insurance policy information via email or SMS. The notification module may inform users of available reports and next steps in the claims process, and the system may log all inquiries and results in a secure, auditable database to ensure compliance with privacy and data protection regulations and to provide an audit trail for regulatory accountability.

In some aspects, the system may include at least one computing device in operable communication with a network and a server in operable communication with the network configured to host the above-described modules as part of a life insurance policy locator platform. The computing device may execute instructions to perform the operations described herein, thereby enabling automated, centralized, and secure life insurance policy discovery that replaces fragmented manual inquiry processes with real-time, API-based access to a cross-carrier insurance industry database. The system may support access from user computing devices, administrator computing devices, and third-party computing devices, each communicating via the network to submit queries, manage access controls, and retrieve life insurance policy details.

The disclosed system addresses inefficiencies in conventional methods for locating life insurance policies associated with deceased individuals. Previous approaches required funeral home providers or family members to contact multiple insurance companies individually through phone calls, emails, or internal database searches limited to each company's own policies. These fragmented processes were time-consuming, prone to errors, and frequently resulted in unclaimed life insurance proceeds being escheated to the state after statutory periods. The disclosed system centralizes life insurance policy searches within a single platform by integrating with an established insurance industry database that aggregates information from multiple insurance carriers, eliminating the need for manual inquiries to individual insurers and providing structured, standardized results through a secure web-based interface.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a system architecture diagram, according to some embodiments;

FIG. 2 illustrates an application program and modules in communication with the computing system, according to some embodiments;

FIG. 3 illustrates a system architecture that facilitates the secure querying and retrieval of life insurance policy data over a network, according to some embodiments;

FIG. 4 illustrates a process flow for querying and retrieving life insurance policy information through the system, according to some embodiments;

FIG. 5 is a flow diagram illustrating an exemplary operational sequence of the Database Access Module, according to some embodiments;

FIG. 6 is a flow diagram illustrating an exemplary operational sequence of the Query Generation Module, according to some embodiments;

FIG. 7 is a flow diagram illustrating an exemplary operational sequence of the Data Retrieval Module, according to some embodiments;

FIG. 8 is a flow diagram illustrating an exemplary operational sequence of the Result Processing Module, according to some embodiments; and

FIG. 9 is a flow diagram illustrating an exemplary end-to-end system operational flow, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The embodiments described herein illustrate various aspects of the system, including its architecture, operational components, and functionalities. The disclosed system enables funeral home providers and private citizens to efficiently search for active life insurance policies using a centralized database, eliminating the inefficiencies associated with conventional methods of policy discovery.

The disclosed system may include at least one computing device in operable communication with a network and a server configured to host and execute a life insurance policy locator platform. The life insurance policy locator platform may include multiple functional modules, each implemented in software, firmware, hardware, or any combination thereof. In some embodiments, the modules may include a database access module configured to establish and manage secure connections between the system and an external life insurance database, such as the Medical Information Bureau (MIB) database, and to authenticate users using multi-factor authentication (MFA) and role-based access control (RBAC) before allowing queries to be executed. A query generation module may construct, format, and transmit search queries to the external life insurance database based on user-provided identifying information, apply encryption techniques to transmitted data to ensure compliance with data protection regulations such as the Health Insurance Portability and Accountability Act (HIPAA), and implement error-checking mechanisms to validate the accuracy and completeness of user input. A data retrieval module may receive and process responses from the external life insurance database containing life insurance policy information associated with a deceased individual, verify that returned data matches original query parameters, and filter results based on predefined criteria. A result processing module may format, standardize, and prepare retrieved life insurance policy data for display and reporting by applying a standardization algorithm to normalize data formats and naming conventions received from multiple insurance providers. A communication module may securely transmit generated reports to authorized users via a web-based interface and may provide an application programming interface (API) that allows third-party funeral service providers to integrate the life insurance lookup functionality into their existing management systems. A notification module may alert users upon successful retrieval of life insurance policy information via email or Short Message Service (SMS). A database engine may manage structured data storage and retrieval operations for the system. A user module may store user preferences, account information, and historical usage data. A display module may generate and display graphic user interfaces for presenting structured reports and system notifications to users.

Conventional methods for locating life insurance policies associated with deceased individuals have relied on highly inefficient manual processes. Previous approaches required funeral home providers or family members to contact multiple insurance companies individually through phone calls, emails, or internal database searches, each of which was limited to that company's own policies. This fragmented approach was extraordinarily time-consuming, prone to errors, often required intermediaries to verify claims causing further delays, and frequently resulted in unclaimed life insurance proceeds being escheated to the state after statutory periods. The absence of any centralized search capability meant that beneficiaries often remained unaware of policies, leading to unnecessary financial burdens and lost benefits. Some industry efforts attempted to simplify the process through policy locator services operated by individual insurance companies or industry groups, but these services still required users to submit requests manually, wait for responses, and navigate multiple platforms with different procedures and requirements. Furthermore, such services did not grant direct programmatic access to policy details across multiple carriers, instead requiring intermediaries to verify claims and leading to further delays. Additionally, due to the proprietary nature of insurance company databases, previous solutions lacked a unified, standardized approach for retrieving policyholder information across different insurers. Policy records, beneficiary designations, and policyholder information were maintained in separate, disconnected systems across hundreds of individual insurance carriers, making comprehensive searches practically impossible without contacting each carrier independently.

The disclosed embodiments address these problems by providing a web-based platform that integrates with an established insurance industry database aggregating information from multiple insurance carriers, enabling funeral home providers and private citizens to conduct real-time searches for life insurance policies associated with deceased individuals through a single, centralized interface. This configuration enables automated, secure, and standardized life insurance policy discovery that eliminates the need for manual inquiries to individual insurance providers, delivers results in real-time with virtually complete accuracy, and normalizes heterogeneous data formats from multiple carriers into uniform structured reports.

In practice and in use, the system may be deployed by funeral home providers, cremation services, estate administrators, or private citizens who need to determine whether a deceased individual maintained active life insurance policies. When a user submits an inquiry through the web-based interface, the database access module authenticates the user via MFA and RBAC. Once authenticated, the user enters identifying information for the deceased individual, such as full name, date of birth, and Social Security number. The query generation module validates the input for required fields, correct formatting, and completeness. If any required information is missing or improperly formatted, the query generation module generates an automated prompt requesting the user to provide or correct the input before proceeding. Once validated, the query generation module applies HIPAA-compliant encryption techniques and formats the query according to the external database's technical specifications. The database access module establishes a secure connection with the external life insurance database, such as the MIB database, and transmits the structured query via secure API calls. The data retrieval module receives the response containing policy-related data from multiple insurance carriers, parses the response to extract policy data fields, verifies data integrity against original query parameters, and filters results based on predefined criteria such as policy status or claim eligibility. If inconsistencies or incomplete records are detected, the data retrieval module may trigger additional queries via the query generation module to refine or supplement the results. The result processing module applies a standardization algorithm to normalize data formats and naming conventions across different insurance providers and generates a structured report summarizing the policy details including insurer name, policy number, face amount, policy status, and beneficiary contact information. The display module presents the structured report on the user's interface, and the notification module sends an email or SMS alerting the user that results are available. All inquiries, queries, responses, and reports are logged in a secure, auditable database to ensure compliance with privacy and data protection regulations.

In this way, the system may improve the process of locating life insurance policies by centralizing and automating searches that previously required weeks or months of manual effort across multiple insurance companies. The integration with an established insurance industry database that aggregates information from multiple carriers eliminates the need for individual inquiries to each insurer. The standardization algorithm ensures that policy data from carriers using different formats and naming conventions is presented uniformly, making results immediately actionable for users. The HIPAA-compliant security implementation including MFA, RBAC, Transport Layer Security (TLS) encryption, and comprehensive audit logging ensures that sensitive policyholder information is protected throughout the retrieval process. The notification module ensures timely communication of results. The API-based integration capability enables third-party funeral service providers to embed the lookup functionality into their existing management systems, extending the utility of the platform beyond direct web-based access. These capabilities reduce policy location time from weeks or months to real-time results, improve accuracy by eliminating manual transcription and fragmented search processes, and minimize the risk of unclaimed insurance benefits being lost to escheatment by enabling timely identification and claim initiation.

Various implementations of the present disclosure involve the technical field of computer-based systems and methods for locating life insurance policies associated with deceased individuals, including executing algorithms to format and encrypt database queries according to external database technical specifications, transmitting structured API calls to an external insurance industry database aggregating data from multiple carriers, receiving and parsing policy-related responses containing heterogeneous data formats from different insurance providers, applying standardization algorithms to normalize data formats and naming conventions across multiple insurers, generating structured reports from normalized data, and logging all system interactions in auditable databases for regulatory compliance. These operations are inherently computer-based and cannot be performed in the human mind or using pen and paper due to the volume, speed, and complexity of the data being processed. For example, the system executes the steps of receiving user inquiries from multiple network-connected devices, authenticating users via MFA and RBAC, encrypting identifying information using HIPAA-compliant protocols, formatting queries according to external database specifications, transmitting API calls across secure network connections, receiving and parsing responses containing policy data from multiple insurance carriers, applying standardization algorithms to normalize heterogeneous data formats, generating structured reports, transmitting notifications, and logging all transactions in auditable databases. The present disclosure amounts to more than merely implementing a generic computer as a tool to gather, analyze, and output data because the claimed operations improve the field of life insurance policy discovery by enabling automated, centralized, and secure access to cross-carrier policy information that was previously accessible only through fragmented, time-consuming manual processes directed to individual insurance companies. In particular, the speed at which the steps of the present disclosure occur to effectuate the disclosed method, system, or product would involve real-time query encryption and formatting, instantaneous secure API transmission to an external database, immediate parsing and standardization of multi-carrier policy data, and real-time report generation and notification delivery. That is, the steps of the present method, system, or product are impossible to accomplish on pen and paper, cannot be accomplished as a method of organizing human activity, and amount to more than merely gathering, analyzing, and outputting data.

Various implementations of the present disclosure include executing computer-implemented encryption algorithms, query formatting routines, API communication protocols, data parsing operations, standardization algorithms, and report generation processes on computing hardware to enable secure, real-time life insurance policy discovery across multiple insurance carriers. The computing system implements these algorithms when it performs tasks such as applying TLS encryption to user-provided identifying information, structuring queries according to MIB database technical specifications, establishing authenticated API connections with the external database, parsing response data to extract policy fields including insurer name, policy number, face amount, and beneficiary contact information, comparing returned data against original query parameters to verify integrity, applying standardization algorithms to normalize varying data formats and naming conventions from different insurance providers, generating structured reports with uniform formatting, and transmitting encrypted notifications to authorized users. In particular, the speed at which the system processes encrypted queries, transmits API calls to an external cross-carrier database, parses and standardizes response data from multiple insurance providers, and generates structured reports would involve continuous, high-frequency data processing across networked systems. As such, the present disclosure would be impossible to accomplish on pen and paper or in the human mind due to the volume of cross-carrier policy data being processed, the number of simultaneous standardization and formatting operations being performed, and the speed required to deliver real-time results to users.

In some embodiments, the database access module processes user authentication requests by coordinating MFA verification and RBAC authorization, establishes encrypted connections with the external life insurance database, transmits structured queries formatted according to database technical specifications, and receives responses containing policy data from multiple insurance carriers. The query generation module receives identifying information from the user interface, applies input validation algorithms to verify completeness and formatting, encrypts validated data using HIPAA-compliant protocols, and formats queries according to the external database's requirements. The data retrieval module receives responses from the external database, parses response data to extract individual policy fields, verifies data integrity by comparing returned data against original query parameters, and applies filtering criteria to streamline output. The result processing module applies standardization algorithms that normalize heterogeneous data formats and naming conventions from multiple insurance providers into uniform structured output. The foregoing operations are executed as sequences of encryption routines, API communications, data parsing operations, algorithmic standardizations, and report generation processes across distributed systems, and cannot practically be performed in the human mind or on paper. These concrete processing steps of secure authentication, encrypted query transmission, cross-carrier data retrieval, automated standardization, and structured report generation provide a specific improvement to life insurance policy discovery systems by enabling centralized, real-time access to policy information across multiple carriers through a single interface, rather than a mere abstract idea of organizing human activity.

The disclosed life insurance policy locator platform incorporates several technical features that distinguish it from conventional methods of locating life insurance policies. In some embodiments, the platform may implement secure, centralized access to a cross-carrier insurance industry database that was previously used exclusively for pre-underwriting risk assessment purposes. The MIB database functions as a shared data repository used by insurance companies to detect fraud, assess risk, and verify application details during the insurance underwriting process. The disclosed system repurposes access to this existing cross-carrier database for post-death policy location services, providing funeral home providers and private citizens with direct programmatic access to an industry-wide resource that aggregates policy information from multiple insurance carriers. This repurposing enables comprehensive searches across policies from multiple insurers simultaneously with a single query, eliminating the need to contact hundreds of insurance companies individually. Unlike conventional systems that search within a single insurance company's internal databases, the disclosed platform queries an external aggregated database that spans the insurance industry, fundamentally changing the scope and efficiency of policy discovery.

In some embodiments, the platform may implement a data standardization architecture that normalizes heterogeneous data formats received from multiple insurance providers into uniform output. Because life insurance carriers use different data formats, naming conventions, field structures, and policy presentation methods, raw data retrieved from the external database may contain inconsistencies that would make interpretation difficult for users. The result processing module addresses this technical challenge by applying a standardization algorithm that normalizes policy details including insurer names, policy numbers, face amounts, policy statuses, and beneficiary contact information into a consistent, structured format. This standardization ensures uniform presentation across various insurers regardless of how each carrier formats its data, making results immediately interpretable and actionable for funeral home providers and private citizens. The standardization algorithm may also perform error-checking and data validation to detect inconsistencies or missing fields, and may communicate with the data retrieval module to refine the data set or flag incomplete entries for further review. This data transformation capability addresses a technical problem that does not exist in single-carrier systems where data formats are internally consistent, and represents a core technical contribution of the disclosed system.

In some embodiments, the platform may implement dynamic query refinement that automatically improves search results when initial queries return partial matches or incomplete records. The query generation module may work in conjunction with the data retrieval module to detect when returned results contain inconsistencies, partial matches, or incomplete policy records. When such conditions are detected, the query generation module may dynamically refine subsequent queries by adjusting search parameters, broadening or narrowing query scope, or reformatting identifying information to improve match accuracy. This iterative refinement process may reduce false positives and ensure that comprehensive policy information is retrieved before results are presented to users. Unlike conventional manual search methods where incomplete results required entirely new inquiry processes to different insurance companies, the disclosed system's automated refinement capability enables progressive improvement of search results within a single query session.

In some embodiments, the platform may implement HIPAA-compliant security measures that protect sensitive policyholder information throughout the entire query-retrieval-reporting workflow. The system may encrypt all user-submitted data in transit using secure communication protocols such as TLS. Access to the system may be restricted through MFA requiring users to verify their identity through multiple authentication methods such as passwords and one-time security codes, and RBAC that restricts access based on user roles to ensure that only authorized individuals such as funeral home providers or verified beneficiaries can perform searches or access sensitive information. The system may maintain detailed audit logs of all access events, queries, data retrievals, and report generations, providing a comprehensive audit trail for compliance and accountability. Additionally, data storage may be handled within secure environments with restricted physical access and regular security monitoring. These security measures collectively ensure that the system aligns with HIPAA Privacy and Security Rules, enabling lawful access to insurance information while safeguarding individuals' personal and health-related data. Unlike conventional manual methods where sensitive information was communicated through unsecured channels such as phone calls and emails, the disclosed platform enforces encryption and access controls at every point of data transmission and retrieval.

In some embodiments, the platform may implement automated notification and reporting capabilities that ensure timely communication of search results to authorized users. The notification module may send email or SMS notifications to users upon successful retrieval of life insurance policy information, informing users of available reports and next steps in the claims process. The result processing module may generate structured reports that can be displayed through the user interface, securely transmitted via the communication module, or exported in various formats such as Portable Document Format (PDF) or JavaScript Object Notation (JSON) for integration with third-party systems. This automated reporting ensures that search results are delivered in a format that is immediately usable by funeral home providers and beneficiaries, reducing the time between policy discovery and claim initiation.

In some embodiments, the platform may implement API-based integration capabilities that enable third-party funeral service providers to embed the life insurance lookup functionality into their existing management systems. The communication module may provide a standardized API through which external systems can submit queries, receive responses, and retrieve structured reports without requiring users to access the platform's web-based interface directly. This integration capability enables funeral home management software, estate planning platforms, and other industry systems to incorporate life insurance policy lookup as a native feature within their existing workflows, extending the utility of the disclosed platform beyond standalone web-based access. The API may implement authentication and encryption requirements consistent with the platform's security framework, ensuring that third-party integrations maintain the same level of data protection as direct web-based access.

In some embodiments, the platform may implement comprehensive audit logging that records all system interactions for regulatory compliance and accountability. The system may log all inquiries submitted by users, queries transmitted to the external database, responses received from the external database, structured reports generated by the result processing module, and notifications transmitted to users. Each logged record may include user identifiers, timestamps, query parameters, response data, and system decisions. This logging mechanism may ensure accountability and provide an audit trail for regulatory compliance reviews, enabling verification of who accessed the system, what searches were conducted, what results were returned, and what reports were generated. The audit logging may address regulatory requirements for maintaining records of access to sensitive policyholder information and may provide defensible documentation in the event of disputes regarding policy claims or data access.

In some embodiments, the platform may support automated retrieval of identifying information from a government-issued death certificate database, reducing the potential for human error in data entry. Rather than requiring users to manually input all identifying details for the deceased individual, the system may interface with government databases containing death certificate records to automatically populate identifying fields such as full name, date of birth, date of death, and Social Security number. This automated retrieval may reduce transcription errors that could result in inaccurate or incomplete search results and may streamline the query submission process for funeral home providers who frequently conduct policy searches as part of their standard service workflow.

These technical features may collectively transform life insurance policy discovery from a fragmented, manual, and time-consuming process into an automated, centralized, and secure system. Whereas conventional methods required beneficiaries and funeral home providers to contact individual insurance companies through unsecured channels, wait days or weeks for responses, and navigate inconsistent procedures across different insurers, the disclosed platform provides immediate, comprehensive, and standardized access to cross-carrier policy information through a single secure interface. By integrating secure database access, encrypted query generation, cross-carrier data retrieval, automated standardization, structured report generation, notification delivery, and comprehensive audit logging into a unified platform, the system addresses fundamental limitations in conventional approaches that separated the policy discovery process across hundreds of independent, disconnected systems.

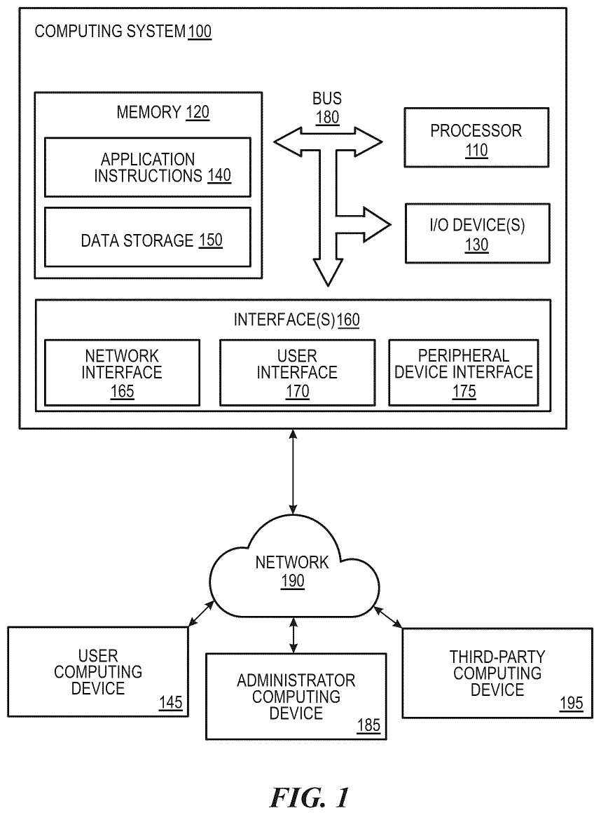

FIG. 1 illustrates an example of a computer system 100 that may be utilized to execute various procedures, including the processes described herein. In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores.

In some embodiments, the memory 120 includes computer-readable application instructions 140, configured to implement certain embodiments described herein, and a database 150, comprising various data accessible by the application instructions 140.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the computer system 100 may include a user computing device 145, an administrator computing device 185 and a third-party computing device 195 each in communication via the network 190. The user computing device 145 may be utilized by a user to interact with the various functionalities of the system. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

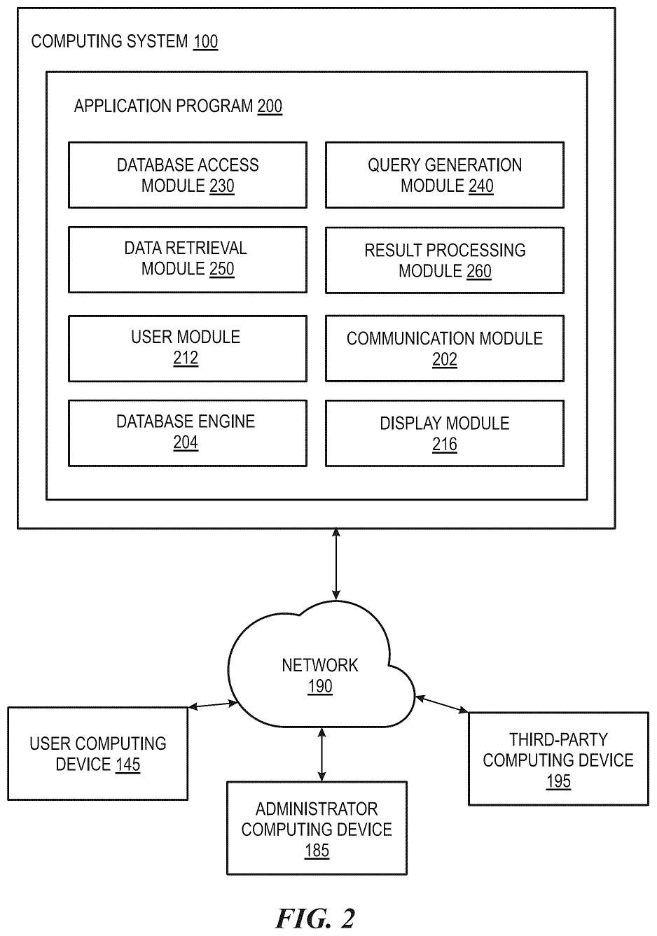

FIG. 2 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a database access module 230, a query generation module 240, a data retrieval module 250, a result processing module 260, a communication module 202, a database engine 204, a user module 212, and a display module 216.

The database access module 230 is responsible for establishing and managing secure connections between the system and an external life insurance database, such as the MIB database. The database access module 230 functions as the intermediary between the user interface and the external data source, ensuring that policy-related information is retrieved efficiently and securely. In operation, the database access module 230 first authenticates users before allowing any queries to be executed. Authentication may involve multi-factor authentication (MFA) and role-based access control (RBAC) to verify that only authorized individuals, such as funeral home providers or beneficiaries, can access the system. Once authentication is confirmed, the module formats and transmits database queries using encrypted API calls or secure communication protocols to maintain data confidentiality and integrity. Upon receiving a response from the external database, the database access module 230 processes the retrieved data and forwards it to the appropriate system components, such as the data retrieval module and result processing module. Additionally, the database access module 230 may implement load-balancing mechanisms to handle multiple concurrent queries without system delays. For security and compliance purposes, all database access events are logged, creating an audit trail that ensures adherence to data protection regulations like HIPAA.

The query generation module 240 is configured to construct and transmit search queries to an external life insurance database, such as the MIB database, based on user-provided identifying information. The query generation module 240 ensures that user input is properly formatted, secured, and optimized for accurate and efficient database retrieval. In operation, the query generation module 240 first receives identifying details from the user interface, such as the deceased individual's full name, date of birth, and Social Security number. To ensure data security, the module may apply encryption techniques before transmitting the query, protecting sensitive information in compliance with privacy regulations such as HIPAA. The query generation module 240 then formats the query according to the database's requirements, normalizing the data structure to align with various insurers' database protocols. Once the query is structured, the module transmits it through a secure API call or encrypted communication channel to the external database. The query generation module 240 may also implement error-checking mechanisms to validate the accuracy and completeness of the input before sending the request. If any required information is missing or improperly formatted, the query generation module 240 may generate an automated prompt requesting the user to provide or correct the input before proceeding. After transmission, the query generation module 240 works in conjunction with the database access module 230 and data retrieval module 250 to ensure an efficient response handling process. If multiple records or partial matches are returned by the database access module 230, the query generation module 240 may refine subsequent queries dynamically to improve search accuracy and reduce false positives. Additionally, the query generation module 240 may log query transactions for auditing and compliance purposes, ensuring transparency in system operations.

The data retrieval module 250 is configured to receive and process responses from an external life insurance database, such as the MIB database, after a query has been transmitted. This module ensures that retrieved data is accurately interpreted, filtered, and prepared for further processing within the system. In operation, the data retrieval module 250 receives a response containing life insurance policy information associated with a deceased individual. The response may include details such as the insurance provider's name, policy number, face amount, policy status, and beneficiary contact information. To ensure data integrity, the data retrieval module 250 verifies that the returned data matches the original query parameters. If inconsistencies or incomplete records are detected, the module may trigger additional queries via the query generation module 240 to refine or supplement the results. The data retrieval module 250 may also apply filtering criteria to streamline the output. For example, it can exclude inactive policies, filter results based on claim eligibility, or sort policies by insurer-specific requirements. If multiple records are returned, the data retrieval module 250 may implement ranking algorithms to prioritize the most relevant matches. Once the data is verified and processed, the data retrieval module 250 forwards the structured results to the result processing module for formatting and display. Additionally, the data retrieval module 250 may log all retrieval transactions to ensure compliance with data privacy regulations and provide an auditable record of search activities.

The result processing module 260 is configured to format, standardize, and prepare retrieved life insurance policy data for display and reporting. The result processing module 260 ensures that the information received from the data retrieval module 250 is structured in a clear, consistent, and accessible format for users such as funeral home providers and private citizens. In operation, the result processing module 260 first receives raw policy data from the data retrieval module 250. Because life insurance providers may use different data formats and naming conventions, the module applies a standardization algorithm to normalize policy details. This process ensures uniform presentation across various insurers, making it easier for users to interpret key information such as policy provider, policy number, face amount, policy status, and beneficiary contact details. The result processing module 260 may also perform error-checking and data validation to detect inconsistencies or missing fields. If discrepancies are found, the result processing module 260 may communicate with the data retrieval module 250 to refine the data set or flag incomplete entries for further review. Additionally, the result processing module 260 may apply sorting and filtering techniques, allowing users to prioritize relevant policies based on predefined criteria such as claim eligibility or insurer-specific requirements. Once the data is processed, the result processing module 260 generates a structured report summarizing the life insurance policy details. This report may be displayed through the user interface, securely transmitted via the communication module, or exported in various formats such as PDF or JSON for integration with third-party systems. The result processing module 260 may also log report generation events to ensure compliance with audit and data protection regulations. By standardizing and refining retrieved policy data, the module enhances usability, ensuring that life insurance benefits can be identified and claimed efficiently.

In some embodiments, the communication module 202 is configured for receiving, processing, and transmitting a user command and/or one or more data streams. In such embodiments, the communication module 202 performs communication functions between various devices, including the user computing device 145 of FIG. 1, the administrator computing device 185 of FIG. 1, and a third-party computing device 195 of FIG. 1. In some embodiments, the communication module 202 is configured to allow one or more users of the system, including a third-party, to communicate with one another. In some embodiments, the communications module 202 is configured to maintain one or more communication sessions with one or more servers, the administrative computing device 185 of FIG. 1, and/or one or more third-party computing device(s) 195 of FIG. 1. In some embodiments, the communication module 202 may allow users and administrators to communicate with one another.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

The user module 212 may store user preferences including the user account information, historical usage data, user personal information, and the like. The user module 212 may facilitate the creation of user's profiles for users, administrators, and others.

In some embodiments, the display module 216 is configured to display one or more graphic user interfaces, including, e.g., one or more user interfaces. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored. The display module 216 displays information, notifications, and alerts to the user device which can be viewed and acknowledged by the user.

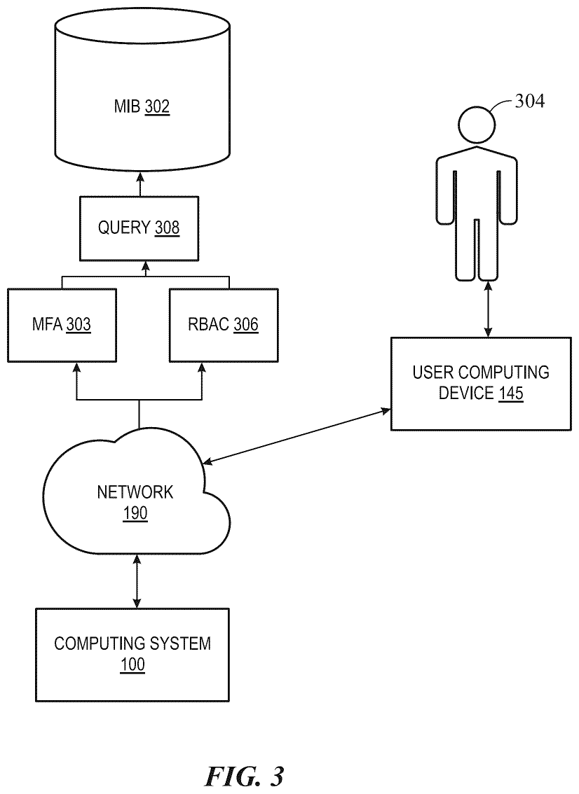

FIG. 3 illustrates a system architecture that facilitates the secure querying and retrieval of life insurance policy data over a network. The figure depicts the interaction between a computing system 100, an external life insurance database such as the MIB database 302, and multiple computing devices (145, 100) accessing the system. The computing system 100 is connected to a network 190, which allows communication between a user 304 computing device 145, an administrator computing device 185 (depicted in FIGS. 1 and 2), and a third-party computing device 195 (depicted in FIG. 1). These devices serve different roles within the system, including submitting queries, managing access, and retrieving life insurance policy details. To ensure secure access control, the system implements multi-factor authentication (MFA) 303 and role-based access control (RBAC) 306 before allowing any queries to be executed. MFA 303 requires users 304 to verify their identity through multiple authentication methods, such as passwords and one-time security codes. RBAC 306 further restricts access based on user 304 roles, ensuring that only authorized individuals, such as funeral home providers or beneficiaries, can perform searches. When an authorized user 304 submits a query 308, the system processes the request by formatting and encrypting the identifying information before transmitting it to the MIB database 302 via the database access module 230 of FIG. 2. Once the external database responds, the retrieved data is passed through the data retrieval module 250 of FIG. 2, which verifies and filters the results before forwarding them to the result processing module 260 of FIG. 2. The final structured report is then transmitted securely to the requesting user or administrator device (145, 100) for review.

In some embodiments, the computing system 100 may establish communication with the MIB database 302 via the network 190 using secure application programming interface (API) calls that transmit encrypted data packets between the computing system 100 and the MIB database 302. The MIB database 302 functions as a shared data repository used by insurance companies to detect fraud, assess risk, and verify application details during the insurance underwriting process. The disclosed system repurposes access to the MIB database 302 for post-death policy location services, enabling authorized users such as funeral home providers and private citizens to retrieve policy-related data associated with a deceased individual across multiple insurance carriers through a single query. The MIB database 302 may store and aggregate policy information from a plurality of insurance carriers, enabling the computing system 100 to conduct comprehensive cross-carrier searches without requiring separate connections to individual insurance company databases.

In some embodiments, the multi-factor authentication (MFA) 303 may require users 304 to provide at least two forms of identity verification before the system grants access to query functionality. The MFA 303 may include a first authentication factor comprising a password or personal identification number and a second authentication factor comprising a one-time security code transmitted to the user's registered device via email or Short Message Service (SMS). The database access module 230 of FIG. 2 may coordinate the MFA 303 verification process by receiving user credentials from the user computing device 145, transmitting authentication challenges, and evaluating responses against stored credential records. When the MFA 303 verification is successful, the database access module 230 may proceed to evaluate the user's role authorization via the role-based access control (RBAC) 306.

In some embodiments, the RBAC 306 may define a plurality of user role categories that determine which system functions and data each user 304 is authorized to access. User role categories may include funeral home provider roles that enable full query and report access, private citizen roles that enable query submission with restricted access to certain policy fields, and administrator roles that enable system configuration and audit log review. The RBAC 306 may retrieve role assignments from the user module 212 of FIG. 2 and compare the user's assigned role against predefined permission sets stored in the database engine 204 of FIG. 2. When the RBAC 306 confirms that the user 304 possesses an authorized role, the system may proceed to accept the query 308 for processing. When the RBAC 306 determines that the user 304 does not possess an authorized role, the system may deny access and generate a notification informing the user 304 that authorization is insufficient to perform the requested operation.

In some embodiments, the query 308 submitted by the authorized user 304 may contain identifying information for the deceased individual, such as full name, date of birth, and Social Security number. The query 308 may be transmitted from the user computing device 145 to the computing system 100 via the network 190 using encrypted communication protocols such as Transport Layer Security (TLS). Upon receipt, the query generation module 240 of FIG. 2 may validate the query 308 for required fields, correct formatting, and completeness before the database access module 230 of FIG. 2 transmits the structured query to the MIB database 302 via secure API calls. The response from the MIB database 302 may include policy-related data from multiple insurance carriers associated with the deceased individual, including insurer names, policy numbers, face amounts, policy statuses, and beneficiary contact information. The data retrieval module 250 of FIG. 2 may receive the response, verify data integrity, and forward the verified data to the result processing module 260 of FIG. 2 for standardization and report generation.

In some embodiments, the administrator computing device 185 may access the computing system 100 via the network 190 to perform administrative functions such as managing user accounts, configuring RBAC 306 permission sets, reviewing audit logs, and monitoring system performance. The third-party computing device 195 may access the computing system 100 via the network 190 through the API provided by the communication module 202 of FIG. 2, enabling third-party funeral service management systems to submit queries and receive structured reports without requiring direct access to the web-based user interface. In some embodiments, all communications between the user computing device 145, the administrator computing device 185, the third-party computing device 195, and the computing system 100 may be encrypted using TLS to maintain data security during transmission of sensitive policyholder information across the network 190.

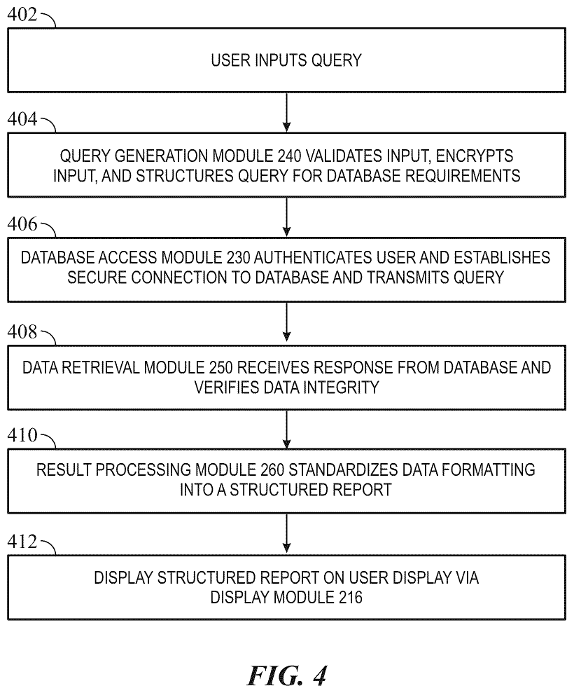

FIG. 4 illustrates a process flow for querying and retrieving life insurance policy information through the system. The diagram outlines how various system modules interact to securely process user queries and return structured results. The process begins, in step 402, with user input, where a funeral home provider, beneficiary, or other authorized user submits an inquiry containing identifying details of the deceased individual, such as name, date of birth, or Social Security number. The query generation module 240, in step 404, then validates the user input by checking for required fields, correct formatting, and potential errors. To ensure data security, the module applies encryption techniques before structuring the query to align with the requirements of the external life insurance database. Next, the database access module 230, in step 406, authenticates the user and establishes a secure connection to the external database, such as the MIB database. The database access module 230 transmits the structured query while enforcing MFA and RBAC to prevent unauthorized access. Upon receiving a response, the data retrieval module 250, in step 408, processes the returned data by verifying its integrity, filtering out incomplete or irrelevant results, and ensuring that all policy details match the user's query. If necessary, this module may initiate additional queries to refine the search results. Once the policy data is verified, the result processing module 260, in step 410, standardizes the formatting across different insurance providers and compiles the results into a structured report. This module ensures uniform data presentation, making it easier for users to review policy details such as the provider name, policy number, coverage amount, and beneficiary information. Finally, the display module 216, in step 412, presents the structured report on the user's interface, allowing them to review the information. The system may also transmit the report securely via encrypted email or provide a downloadable document for future reference.

In some embodiments, step 402 may involve the user submitting the inquiry through a web-based interface generated by the display module 216 and transmitted to the user computing device 145 via the network 190. The inquiry may contain identifying details of the deceased individual including the individual's full name, date of birth, and Social Security number. In some embodiments, the user interface may support automated retrieval of identifying information from a government-issued death certificate database, enabling the system to automatically populate identifying fields rather than requiring manual input. This automated retrieval may reduce transcription errors that could result in inaccurate or incomplete search results and may streamline the query submission process for funeral home providers who frequently conduct policy searches as part of their standard service workflow.

In some embodiments, step 404 may involve the query generation module 240 performing multiple validation operations on the user-provided identifying information. The query generation module 240 may check whether all required fields are populated, verify that data values conform to expected formats such as valid date formats for date of birth and proper digit counts for Social Security numbers, and detect potential errors such as transposed characters or implausible date values. When the query generation module 240 detects that required information is missing or improperly formatted, it may generate an automated prompt transmitted to the user computing device 145 via the display module 216 requesting the user to provide or correct the input before proceeding. Once the input passes validation, the query generation module 240 may apply encryption techniques compliant with the Health Insurance Portability and Accountability Act (HIPAA) to the identifying information, ensuring that sensitive data is protected during transmission. The query generation module 240 may then structure the encrypted query according to the technical specifications of the external life insurance database, such as the MIB database 302 of FIG. 3, formatting data fields to align with the database's expected query structure and protocol requirements.

In some embodiments, step 406 may involve the database access module 230 performing authentication and connection operations in a defined sequence. The database access module 230 may first verify that the user has successfully completed MFA 303 of FIG. 3 and possesses an authorized role via RBAC 306 of FIG. 3 before establishing a connection with the external database. The database access module 230 may then establish a secure connection with the MIB database 302 of FIG. 3 using encrypted API calls transmitted over TLS-protected channels via the network 190. Once the secure connection is established, the database access module 230 may transmit the structured query received from the query generation module 240 to the MIB database 302 of FIG. 3. In some embodiments, the database access module 230 may implement load-balancing mechanisms to handle a plurality of concurrent queries from multiple users without system delays, distributing query processing across available connection resources to maintain system responsiveness.

In some embodiments, step 408 may involve the data retrieval module 250 performing multiple verification and filtering operations on the response received from the external database. The data retrieval module 250 may parse the response to extract individual policy data fields including the insurance provider's name, policy number, face amount, policy status, and beneficiary contact information for each policy record returned. The data retrieval module 250 may verify that the returned data matches the original query parameters by comparing identifying information in the response against the identifying information submitted in the original query. When the data retrieval module 250 detects inconsistencies between the returned data and the original query parameters, or when incomplete records are returned, the data retrieval module 250 may trigger additional queries via the query generation module 240 to refine or supplement the results. In some embodiments, the data retrieval module 250 may apply filtering criteria to exclude inactive policies, filter results based on claim eligibility, or sort policies by insurer-specific requirements. When multiple records are returned, the data retrieval module 250 may implement ranking algorithms to prioritize the most relevant matches before forwarding the verified and filtered results to the result processing module 260.

In some embodiments, step 410 may involve the result processing module 260 performing standardization operations that address the technical challenge of heterogeneous data formats across multiple insurance providers. Because different insurance carriers may use different data formats, naming conventions, field structures, and policy presentation methods, the result processing module 260 may apply a standardization algorithm to normalize policy details into a consistent, structured format. The standardization algorithm may normalize insurer names, standardize policy number formats, convert face amount values to uniform currency representations, harmonize policy status terminology across carriers, and format beneficiary contact information into consistent address and communication fields. The result processing module 260 may also perform error-checking and data validation to detect inconsistencies or missing fields in the standardized output. Once the data is processed, the result processing module 260 may generate a structured report summarizing the life insurance policy details, which may be formatted for display through the user interface, securely transmitted via the communication module 202, or exported in various formats such as Portable Document Format (PDF) or JavaScript Object Notation (JSON) for integration with third-party systems.

In some embodiments, step 412 may involve the display module 216 rendering the structured report on the user's computing device 145 through a web-based interface transmitted via the network 190. The structured report may present policy details in an organized layout that enables the user to review insurer names, policy numbers, face amounts, policy statuses, and beneficiary contact information for each identified policy. In some embodiments, the system may also transmit the report securely via encrypted email or provide a downloadable document for future reference through the communication module 202. The notification module may send an email or SMS notification to the user informing the user that policy information has been successfully retrieved and is available for review. In some embodiments, the system may log all actions performed during steps 402 through 412, including the inquiry submission, query validation, query transmission, response receipt, data verification, standardization processing, report generation, and report delivery, in a secure, auditable database maintained by the database engine 204 of FIG. 2. This logging mechanism may ensure accountability and provide an audit trail for regulatory compliance.

In some embodiments, the operations of steps 402 through 412 may occur automatically upon receipt of a user inquiry, while in other embodiments certain steps may require user confirmation before proceeding, such as confirming the accuracy of identifying information before query transmission. The automated execution of these steps may reduce policy location time from weeks or months to real-time results by eliminating manual processes that previously required funeral home providers or family members to contact multiple insurance companies individually through phone calls, emails, and independent database searches. By integrating authentication, query generation, encrypted transmission, cross-carrier data retrieval, automated standardization, and structured report generation into a single coordinated workflow, the system may ensure that comprehensive policy information is retrieved, verified, standardized, and presented to the user within a single query session.

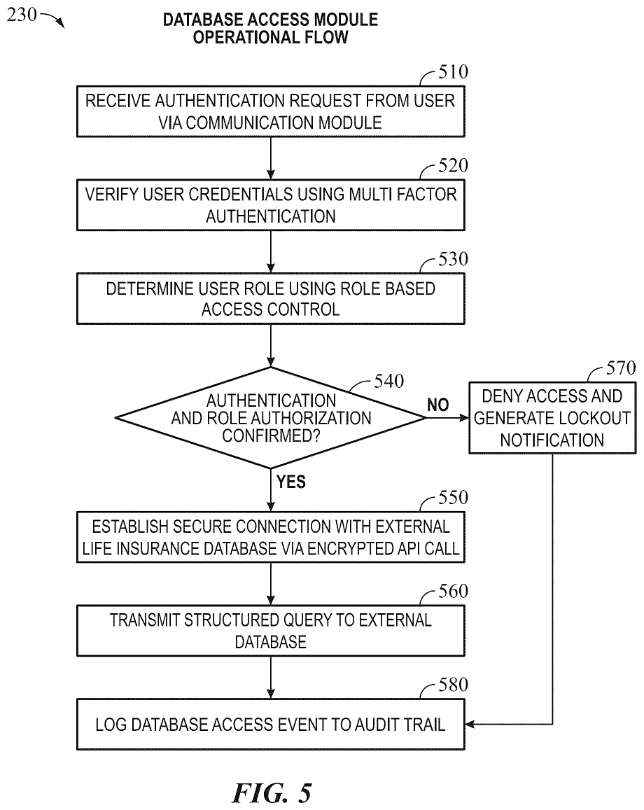

FIG. 5 is a flow diagram illustrating an exemplary operational sequence of the database access module 230 in accordance with certain embodiments. The sequence shown may be implemented as computer-executable instructions within the application program 200 operating on computing system 100 of FIG. 2, with specific operations performed by the modules depicted therein. The database access module 230 is responsible for establishing and managing secure connections between the computing system 100 and an external life insurance database, such as the Medical Information Bureau (MIB) database 302 of FIG. 3, and for authenticating users before allowing access to the external life insurance database.

At step 510, an authentication request is received from a user via the communication module 202. This operation may be performed by the database access module 230 in coordination with the communication module 202 of FIG. 2. In some embodiments, a user 304 may initiate an inquiry through a web-based interface displayed on a user computing device 145 of FIG. 1 or a third-party computing device 195 of FIG. 1. The communication module 202 may receive the authentication request via the network 190 of FIG. 1 and forward the request to the database access module 230 for processing. The authentication request may include user-provided credentials such as a username and password, along with a session identifier linking the request to the user's active session on the user computing device 145. In some embodiments, the authentication request may also include device identification information associated with the user computing device 145, enabling the database access module 230 to verify that the request originates from a recognized device. The database access module 230 may extract the user-provided credentials and device identification information from the received authentication request and initiate the verification process described in step 520.

At step 520, user credentials are verified using multi-factor authentication (MFA). This operation is performed by the database access module 230, which coordinates the MFA 303 verification process described with reference to FIG. 3. In some embodiments, the database access module 230 may compare the user-provided username and password received in step 510 against stored credential records maintained in the database engine 204 of FIG. 2. When the username and password match stored credential records, the database access module 230 may initiate a second authentication factor by generating a one-time security code and transmitting the code to the user's registered device via email or Short Message Service (SMS) through the communication module 202. The database access module 230 may then receive the user's response containing the entered one-time security code via the communication module 202 and compare the entered code against the generated code to determine whether the codes match. In some embodiments, the one-time security code may expire after a predetermined time period, such as sixty seconds or five minutes, after which the database access module 230 may require generation of a new code. When both authentication factors are successfully verified, the database access module 230 may proceed to step 530 to determine the user's role authorization. When either authentication factor fails, such as when the password does not match stored records or the entered one-time security code does not match the generated code, the database access module 230 may proceed to step 540 where the authentication failure is evaluated.

At step 530, the user role is determined using role-based access control (RBAC). This operation is performed by the database access module 230, which implements the RBAC 306 described with reference to FIG. 3. In some embodiments, the database access module 230 may query the user module 212 of FIG. 2 to retrieve the role assignment associated with the authenticated user 304. The user module 212 may store user role assignments that define which system functions and data each user 304 is authorized to access. User role categories may include funeral home provider roles that enable full query and report access, private citizen roles that enable query submission with restricted access to certain policy fields, and administrator roles that enable system configuration and audit log review. The database access module 230 may compare the retrieved role assignment against predefined permission sets stored in the database engine 204 to determine whether the user 304 possesses a role that authorizes access to the external life insurance database. In some embodiments, the permission sets may define granular access levels specifying which types of queries a user may submit, which policy data fields a user may view in returned results, and whether a user may export or transmit generated reports. The database access module 230 may generate an authorization determination based on the comparison between the user's assigned role and the applicable permission set, and may proceed to step 540 where the combined authentication and authorization results are evaluated.

At step 540, a determination is made regarding whether authentication and role authorization are confirmed. This operation is performed by the database access module 230 based on the verification results from step 520 and the authorization results from step 530. In some embodiments, the database access module 230 may evaluate both the MFA 303 verification result and the RBAC 306 authorization result to determine whether the user 304 has satisfied all access requirements. The determination may require that both the MFA 303 verification is successful and the RBAC 306 authorization confirms that the user possesses a role with sufficient permissions to access the external life insurance database. When the determination indicates that both authentication and role authorization are confirmed, the process proceeds along the “Yes” path to step 550 where a secure connection with the external database is established. When the determination indicates that either authentication has failed or role authorization is not confirmed, such as when the user's credentials are invalid, the one-time security code has expired, or the user's assigned role does not include permissions to access the external database, the process proceeds along the “No” path to step 570 where access is denied.

At step 550, a secure connection is established with the external life insurance database via an encrypted application programming interface (API) call. This operation is performed by the database access module 230 when the determination in step 540 confirms that authentication and role authorization are both verified. In some embodiments, the database access module 230 may initiate a connection request to the MIB database 302 of FIG. 3 via the network 190 using encrypted communication protocols such as Transport Layer Security (TLS). The connection request may include authentication credentials specific to the system's authorized access to the MIB database 302, which may be separate from the user-level credentials verified in steps 520 and 530. The database access module 230 may perform a handshake process with the MIB database 302 to establish an encrypted communication channel through which query data and response data may be transmitted securely. In some embodiments, the database access module 230 may verify the identity of the MIB database 302 through certificate validation to ensure that the connection is established with the legitimate database server and not a malicious intermediary. Once the secure connection is established, the database access module 230 may signal readiness to receive the structured query from the query generation module 240 of FIG. 2 for transmission to the MIB database 302. In some embodiments, the database access module 230 may implement load-balancing mechanisms to handle a plurality of concurrent queries from multiple users without system delays, distributing query processing across available connection resources to maintain system responsiveness.

At step 560, the structured query is transmitted to the external database. This operation is performed by the database access module 230 using the secure connection established in step 550. In some embodiments, the database access module 230 may receive the structured query from the query generation module 240 of FIG. 2, where the query has been validated, encrypted, and formatted according to the technical specifications of the MIB database 302 of FIG. 3 as described with reference to FIG. 4. The database access module 230 may transmit the structured query to the MIB database 302 through the encrypted API connection established in step 550 via the network 190. The transmitted query may contain encrypted identifying information for the deceased individual, such as full name, date of birth, and Social Security number, formatted in a data structure compatible with the MIB database 302 query protocol. In some embodiments, the database access module 230 may monitor the transmission to confirm successful delivery of the query and may implement retry mechanisms when transmission failures are detected, such as when network interruptions occur during data transfer. Upon successful transmission, the database access module 230 may await a response from the MIB database 302 containing policy-related data associated with the deceased individual from multiple insurance carriers. When the response is received, the database access module 230 may forward the response to the data retrieval module 250 of FIG. 2 for parsing, verification, and filtering operations.

At step 570, access is denied and a lockout notification is generated. This operation is performed by the database access module 230 when the determination in step 540 indicates that authentication has failed or role authorization is not confirmed. In some embodiments, the database access module 230 may generate an access denial record documenting which verification step failed and the reason for the failure. When MFA 303 verification failed, the access denial record may indicate whether the failure resulted from incorrect credentials, an expired one-time security code, or exceeding a maximum number of authentication attempts. When RBAC 306 authorization failed, the access denial record may indicate that the user's assigned role does not include permissions to access the external life insurance database. The database access module 230 may transmit a lockout notification to the user computing device 145 via the communication module 202 and the display module 216 of FIG. 2, informing the user 304 that access has been denied and identifying the reason for the denial. In some embodiments, the lockout notification may include instructions for resolving the access failure, such as resetting credentials, requesting a new one-time security code, or contacting an administrator to update role assignments. The database access module 230 may implement progressive lockout measures where repeated failed authentication attempts within a specified time period result in temporary account suspension, preventing unauthorized access attempts through brute-force credential attacks.

At step 580, the database access event is logged to the audit trail. This operation is performed by the database access module 230 regardless of whether access was granted in step 550 or denied in step 570. In some embodiments, the database access module 230 may generate a timestamped log record documenting the authentication request received in step 510, the MFA 303 verification result from step 520, the RBAC 306 authorization result from step 530, the combined determination from step 540, and the subsequent action taken in either step 550, step 560, or step 570. The log record may include the user identifier, the user's assigned role, the timestamp of each action performed during the sequence, the device identification information associated with the user computing device 145, and the outcome of the database access attempt. The database access module 230 may transmit the log record to the database engine 204 of FIG. 2 for storage in a secure, auditable database. In some embodiments, the audit trail may implement tamper-evident logging mechanisms that prevent modification or deletion of stored log records, ensuring that the records may serve as verifiable documentation for regulatory compliance reviews. The comprehensive logging of both successful and unsuccessful access attempts may ensure accountability and provide a complete audit trail documenting who accessed or attempted to access the system, when access occurred, and what actions were taken, enabling compliance with data protection regulations such as the Health Insurance Portability and Accountability Act (HIPAA).

In some embodiments, the operations of steps 510 through 580 may occur automatically each time a user submits an inquiry through the web-based interface. The automated execution of these authentication, authorization, connection, and transmission steps may eliminate manual verification processes that would otherwise require administrators to review and approve each access request individually. By integrating MFA 303 verification, RBAC 306 authorization, encrypted API connection establishment, and comprehensive audit logging into a single coordinated sequence, the database access module 230 may ensure that only authenticated and authorized users can access the external life insurance database while maintaining a complete record of all access events for regulatory compliance. In some embodiments, the entire sequence from authentication request receipt at step 510 through query transmission at step 560 may execute within seconds, enabling real-time access to cross-carrier policy information that would otherwise require weeks or months of manual inquiry processes directed to individual insurance companies.

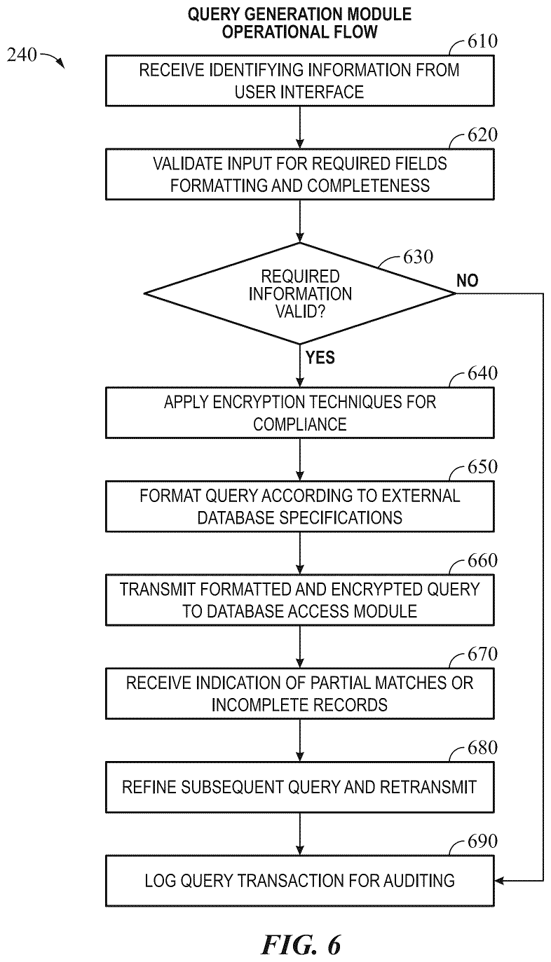

FIG. 6 is a flow diagram illustrating an exemplary operational sequence of the query generation module 240 in accordance with certain embodiments. The sequence shown may be implemented as computer-executable instructions within the application program 200 operating on computing system 100 of FIG. 2, with specific operations performed by the modules depicted therein. The query generation module 240 is configured to construct, format, and transmit search queries to an external life insurance database, such as the Medical Information Bureau (MIB) database 302 of FIG. 3, based on user-provided identifying information. The query generation module 240 ensures that user input is properly validated, secured through encryption, and optimized for accurate and efficient database retrieval.

At step 610, identifying information is received from the user interface. This operation may be performed by the query generation module 240 in coordination with the display module 216 and the communication module 202 of FIG. 2. In some embodiments, a user 304 of FIG. 3 may enter identifying details for a deceased individual through a web-based interface displayed on the user computing device 145 of FIG. 1. The identifying information may include the deceased individual's full name, date of birth, and Social Security number. The display module 216 may capture the entered information through input fields rendered on the user computing device 145 and transmit the captured data to the query generation module 240 via the communication module 202. In some embodiments, the user interface may support automated retrieval of identifying information from a government-issued death certificate database, enabling the system to automatically populate identifying fields rather than requiring manual input from the user 304. When automated retrieval is used, the query generation module 240 may receive pre-populated identifying fields along with a source identifier indicating that the data originated from a government database. The query generation module 240 may store the received identifying information in a temporary data structure in the memory 120 of FIG. 1 for processing in subsequent steps.

At step 620, the input is validated for required fields, formatting, and completeness. This operation is performed by the query generation module 240, which implements error-checking mechanisms to verify the accuracy and completeness of the identifying information received in step 610. In some embodiments, the query generation module 240 may check whether all required fields are populated by comparing the received data against a predefined field requirement list that specifies which identifying details are mandatory for query submission. The query generation module 240 may verify that data values conform to expected formats, such as validating that the date of birth contains a properly structured date value with month, day, and year components, that the Social Security number contains the expected number of digits without alphabetic characters, and that the full name field contains at least a first name and last name separated by appropriate delimiters. In some embodiments, the query generation module 240 may perform additional validation operations such as detecting implausible date values where the date of birth indicates a future date or an age exceeding plausible human lifespan, identifying transposed digits in the Social Security number by applying check-digit verification algorithms, and detecting duplicate or conflicting entries when automated retrieval and manual input are both used for the same field. The query generation module 240 may compile the results of all validation operations into a validation status object that indicates whether the input passes or fails the validation requirements, and may proceed to step 630 where the validation status is evaluated.

At step 630, a determination is made regarding whether the required information is valid. This operation is performed by the query generation module 240 based on the validation results compiled in step 620. In some embodiments, the query generation module 240 may evaluate the validation status object to determine whether all required fields are populated, all data values conform to expected formats, and no errors or implausible values have been detected. When the determination indicates that the required information is valid and complete, the process proceeds along the “Yes” path to step 640 where encryption techniques are applied. When the determination indicates that the required information is not valid, such as when required fields are empty, data values do not conform to expected formats, or errors have been detected, the process proceeds along the “No” path. In some embodiments, when the input fails validation, the query generation module 240 may generate an automated prompt identifying which fields require correction and transmit the prompt to the user computing device 145 via the display module 216 and the communication module 202 of FIG. 2. The automated prompt may specify the nature of each detected error, such as indicating that a required field is empty, that a date value is improperly formatted, or that a Social Security number contains an incorrect number of digits. The user 304 may then correct the identified errors and resubmit the identifying information, at which point the query generation module 240 may repeat the validation operations of step 620 on the corrected input. This iterative validation process may continue until the input passes all validation requirements, at which point the process proceeds to step 640.

At step 640, encryption techniques are applied to the validated input for compliance with data protection regulations. This operation is performed by the query generation module 240 when the determination in step 630 confirms that the identifying information is valid and complete. In some embodiments, the query generation module 240 may apply encryption algorithms compliant with the Health Insurance Portability and Accountability Act (HIPAA) to the validated identifying information. The encryption process may involve encoding the identifying information using Transport Layer Security (TLS) protocols to ensure that sensitive data including the deceased individual's full name, date of birth, and Social Security number is protected during transmission across the network 190 of FIG. 1. In some embodiments, the query generation module 240 may apply field-level encryption to individual data elements within the identifying information, encrypting each field independently using symmetric or asymmetric encryption algorithms before the fields are assembled into a query structure. The query generation module 240 may retrieve encryption keys from a secure key management system maintained by the database engine 204 of FIG. 2, ensuring that encryption keys are stored separately from the data they protect. The encrypted identifying information may be stored in a secure temporary data structure in the memory 120 of FIG. 1 for use in the formatting operations of step 650.

At step 650, the query is formatted according to external database specifications. This operation is performed by the query generation module 240, which structures the encrypted identifying information into a query format compatible with the technical specifications of the external life insurance database. In some embodiments, the query generation module 240 may retrieve database specification parameters from the database engine 204 of FIG. 2 that define the expected query structure, field ordering, data type requirements, and protocol conventions for the MIB database 302 of FIG. 3. The query generation module 240 may map the encrypted identifying information fields to corresponding fields in the database query structure, converting data representations as needed to align with the MIB database 302 protocol requirements. For example, the query generation module 240 may convert date of birth values to a specific date format expected by the MIB database 302, arrange name fields in a specific order such as last name followed by first name and middle initial, and encode the Social Security number in a format compatible with the database's identifier matching system. In some embodiments, the query generation module 240 may append metadata to the formatted query including a unique query identifier, a timestamp indicating when the query was generated, and a requesting system identifier that enables the MIB database 302 to authenticate the query source. The formatted and encrypted query may represent the query 308 of FIG. 3 in its final transmission-ready state. The query generation module 240 may proceed to step 660 to transmit the formatted query.

At step 660, the formatted and encrypted query is transmitted to the database access module 230. This operation is performed by the query generation module 240, which forwards the formatted query to the database access module 230 of FIG. 2 for transmission to the external life insurance database. In some embodiments, the query generation module 240 may transmit the formatted query to the database access module 230 through an internal communication channel within the computing system 100, where the database access module 230 may then transmit the query to the MIB database 302 of FIG. 3 via the secure API connection established at step 550 of FIG. 5. The query generation module 240 may include transmission verification mechanisms that confirm the database access module 230 has successfully received the formatted query before proceeding. In some embodiments, when the database access module 230 reports that the secure connection with the MIB database 302 has failed or been interrupted, such as when network disruptions occur during the transmission process or when the MIB database 302 is temporarily unavailable, the query generation module 240 may retain the formatted query in the memory 120 of FIG. 1 and reattempt transmission after a predetermined waiting period. The query generation module 240 may implement a configurable retry limit specifying the maximum number of transmission attempts before generating a failure notification to the user 304 via the display module 216 informing the user that the query could not be completed and recommending that the user attempt the inquiry again at a later time. Upon successful transmission, the query generation module 240 may await indication from the data retrieval module 250 of FIG. 2 regarding whether the returned results require refinement.

At step 670, an indication of partial matches or incomplete records is received from the data retrieval module 250. This operation is performed by the query generation module 240, which receives feedback from the data retrieval module 250 of FIG. 2 following the data retrieval module's processing of the response from the external life insurance database. In some embodiments, the data retrieval module 250 may detect that the response from the MIB database 302 of FIG. 3 contains partial matches where some but not all identifying information fields match the query parameters, incomplete records where policy data fields such as beneficiary contact information or face amounts are missing, or ambiguous matches where multiple policy records share similar but not identical identifying details. The data retrieval module 250 may transmit a refinement request to the query generation module 240 identifying which aspects of the returned results are incomplete or ambiguous and suggesting which query parameters may be adjusted to improve result accuracy. In some embodiments, the refinement request may include specific data points from the partial matches that could be used to construct more targeted subsequent queries, such as insurer identifiers associated with incomplete records that may yield more complete data when queried individually.

At step 680, the subsequent query is dynamically refined and retransmitted. This operation is performed by the query generation module 240, which modifies the original query based on the refinement request received in step 670. In some embodiments, the query generation module 240 may adjust search parameters by broadening the query scope to capture records that may have been excluded by overly restrictive matching criteria, narrowing the query scope to eliminate ambiguous matches by including additional identifying details, or reformatting identifying information to accommodate alternative naming conventions or data representations used by specific insurance carriers. The query generation module 240 may apply the same encryption techniques described in step 640 and formatting operations described in step 650 to the refined query before transmitting the refined query to the database access module 230 for retransmission to the MIB database 302 of FIG. 3 via the process described in step 660. In some embodiments, the query generation module 240 may implement a refinement iteration limit specifying the maximum number of query refinement cycles to prevent indefinite looping when results cannot be improved through parameter adjustment. When the refinement iteration limit is reached, the query generation module 240 may signal the data retrieval module 250 to proceed with the best available results. This dynamic query refinement capability may reduce false positives and ensure that comprehensive policy information is retrieved before results are presented to the user 304.

At step 690, the query transaction is logged for auditing and compliance purposes. This operation is performed by the query generation module 240 regardless of whether the query was transmitted successfully in step 660 or required refinement through steps 670 and 680. In some embodiments, the query generation module 240 may generate a timestamped log record documenting the identifying information received in step 610, the validation results from step 620, the validation determination from step 630, the encryption operations performed in step 640, the formatting operations performed in step 650, the transmission outcome from step 660, and any refinement operations performed in steps 670 and 680. The log record may include the unique query identifier appended during step 650, the user identifier associated with the user 304 who submitted the inquiry, timestamps for each operation performed during the sequence, and the final transmission status indicating whether the query was successfully delivered to the external database. The query generation module 240 may transmit the log record to the database engine 204 of FIG. 2 for storage in a secure, auditable database. In some embodiments, the log record may be cross-referenced with the access event log generated at step 580 of FIG. 5 using the unique query identifier, enabling reconstruction of the complete query lifecycle from user authentication through query transmission for regulatory compliance reviews. The comprehensive logging of query generation operations may ensure that all data handling activities involving sensitive identifying information are documented and auditable in compliance with HIPAA requirements.

In some embodiments, the operations of steps 610 through 690 may occur automatically following successful user authentication and authorization by the database access module 230 as described with reference to FIG. 5. The automated execution of input validation, encryption, formatting, and transmission steps may eliminate manual processes where funeral home providers or family members previously had to format inquiry letters, determine which insurance companies to contact, and submit separate requests to each individual insurer. By integrating input validation, HIPAA-compliant encryption, database-specific query formatting, and dynamic query refinement into a single coordinated sequence, the query generation module 240 may ensure that user-provided identifying information is verified, secured, and optimally formatted before transmission to the external life insurance database, improving both the accuracy and security of the policy search process.

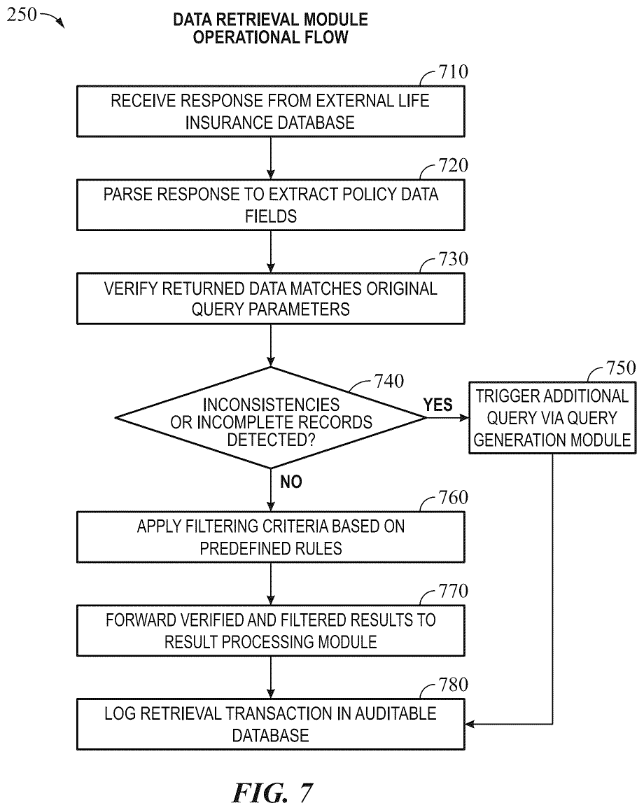

FIG. 7 is a flow diagram illustrating an exemplary operational sequence of the data retrieval module 250 in accordance with certain embodiments. The sequence shown may be implemented as computer-executable instructions within the application program 200 operating on computing system 100 of FIG. 2, with specific operations performed by the modules depicted therein. The data retrieval module 250 is configured to receive and process responses from an external life insurance database, such as the Medical Information Bureau (MIB) database 302 of FIG. 3, after a query has been transmitted by the database access module 230 of FIG. 2. The data retrieval module 250 ensures that retrieved data is accurately interpreted, verified against original query parameters, filtered according to predefined criteria, and prepared for further processing by the result processing module 260 of FIG. 2.

At step 710, a response is received from the external life insurance database. This operation may be performed by the data retrieval module 250 in coordination with the database access module 230 of FIG. 2. In some embodiments, following transmission of the structured query to the MIB database 302 of FIG. 3 at step 560 of FIG. 5, the MIB database 302 may process the received query by searching its aggregated policy records from multiple insurance carriers and generating a response containing matching policy data. The database access module 230 may receive the response from the MIB database 302 via the secure API connection established at step 550 of FIG. 5 and forward the response to the data retrieval module 250 for processing. The response may contain policy-related data from a plurality of insurance carriers associated with the deceased individual, including data fields for insurer names, policy numbers, face amounts, policy statuses, and beneficiary contact information. In some embodiments, the response may contain multiple policy records when the deceased individual maintained life insurance policies with more than one insurance carrier. The response may also include metadata such as response timestamps, record counts indicating the number of matching policy records, and data source identifiers indicating which insurance carriers contributed records to the response. The data retrieval module 250 may store the received response in a temporary data structure in the memory 120 of FIG. 1 for processing in subsequent steps.

At step 720, the response is parsed to extract policy data fields. This operation is performed by the data retrieval module 250, which processes the raw response data received in step 710 to identify and extract individual policy data fields from each policy record contained in the response. In some embodiments, the data retrieval module 250 may parse the response by identifying field delimiters, record boundaries, and data type markers within the response data structure. For each policy record, the data retrieval module 250 may extract the insurance provider's name, the policy number assigned by the insurance carrier, the face amount representing the policy's death benefit value, the policy status indicating whether the policy is active, lapsed, or matured, and the beneficiary contact information including names, addresses, telephone numbers, and email addresses associated with designated beneficiaries. In some embodiments, the data retrieval module 250 may encounter policy records formatted in different data structures depending on the originating insurance carrier, as different carriers may organize policy data fields in different orders, use different field naming conventions, or encode data values in different formats. The data retrieval module 250 may apply data mapping rules stored in the database engine 204 of FIG. 2 to identify equivalent fields across different carrier data structures, ensuring that policy provider names, policy numbers, face amounts, and beneficiary contact details are correctly extracted regardless of the originating carrier's data format. The extracted policy data fields may be organized into a standardized intermediate data structure for processing in subsequent steps.

At step 730, the returned data is verified against original query parameters. This operation is performed by the data retrieval module 250, which compares identifying information contained in the returned policy records against the identifying information submitted in the original query. In some embodiments, the data retrieval module 250 may retrieve the original query parameters from the memory 120 of FIG. 1, where the query generation module 240 of FIG. 2 stored them during the query formatting process described with reference to FIG. 6. The data retrieval module 250 may compare the deceased individual's name, date of birth, and Social Security number as they appear in each returned policy record against the corresponding values in the original query to determine whether the returned records accurately match the queried individual. The verification process may account for minor variations in name formatting, such as differences in middle name representation, hyphenated surnames, or abbreviated first names, by applying fuzzy matching algorithms that evaluate the degree of similarity between compared values. In some embodiments, the data retrieval module 250 may assign a match confidence score to each returned policy record based on the degree of correspondence between the record's identifying information and the original query parameters. Policy records with match confidence scores above a predetermined threshold may be classified as verified matches, while records with scores below the threshold may be classified as potential matches requiring further evaluation. The verification results may be compiled into a verification status object associated with each extracted policy record for evaluation in step 740.

At step 740, a determination is made regarding whether inconsistencies or incomplete records are detected. This operation is performed by the data retrieval module 250 based on the verification results compiled in step 730 and the completeness of policy data fields extracted in step 720. In some embodiments, the data retrieval module 250 may evaluate each policy record to determine whether the verification status indicates accurate matching with the original query parameters and whether all expected policy data fields have been successfully extracted. The data retrieval module 250 may detect inconsistencies when match confidence scores fall below the predetermined threshold, when identifying information in returned records conflicts with original query parameters, or when policy records contain contradictory data values. The data retrieval module 250 may detect incomplete records when expected policy data fields such as face amounts, beneficiary contact information, or policy status values are missing or contain null values. When the determination indicates that inconsistencies or incomplete records are detected, the process proceeds along the “Yes” path to step 750 where additional queries are triggered. When the determination indicates that no inconsistencies or incomplete records are detected and all returned policy records contain complete, verified data, the process proceeds along the “No” path to step 760 where filtering criteria are applied.

At step 750, an additional query is triggered via the query generation module 240. This operation is performed by the data retrieval module 250 when the determination in step 740 indicates that inconsistencies or incomplete records have been detected in the returned results. In some embodiments, the data retrieval module 250 may generate a refinement request identifying which policy records contain inconsistencies or incomplete data fields and transmit the refinement request to the query generation module 240 as described at step 670 of FIG. 6. The refinement request may specify which aspects of the returned results require improvement, such as identifying specific insurance carriers whose records were incomplete, specific policy data fields that were missing, or specific identifying information discrepancies that may be resolved through adjusted query parameters. The query generation module 240 may then dynamically refine a subsequent query as described at step 680 of FIG. 6 and retransmit the refined query to the MIB database 302 of FIG. 3 through the database access module 230. In some embodiments, the data retrieval module 250 may retain the verified and complete policy records from the initial response while awaiting supplementary results from the refined query, enabling the system to progressively build a comprehensive result set through iterative refinement. When the refined query response is received, the data retrieval module 250 may repeat the parsing operations of step 720, the verification operations of step 730, and the evaluation of step 740 on the supplementary results. This iterative process may continue until the data retrieval module 250 determines that no further inconsistencies or incomplete records remain, or until the refinement iteration limit configured in the query generation module 240 is reached, at which point the process proceeds to step 760.

At step 760, filtering criteria are applied based on predefined rules. This operation is performed by the data retrieval module 250 when the determination in step 740 indicates that no inconsistencies or incomplete records remain, or following completion of the iterative refinement process described in step 750. In some embodiments, the data retrieval module 250 may apply filtering criteria to streamline the output by evaluating each verified policy record against predefined rules stored in the database engine 204 of FIG. 2. The filtering criteria may include policy status filters that exclude inactive, cancelled, or expired policies and retain only active policies with current claim eligibility. The filtering criteria may include claim eligibility filters that evaluate whether policy conditions such as contestability periods, exclusion clauses, or beneficiary designation requirements affect the ability to initiate a claim. The filtering criteria may include insurer-specific requirement filters that account for varying claims procedures, documentation requirements, or notification periods established by different insurance carriers. In some embodiments, when multiple verified policy records remain after filtering, the data retrieval module 250 may implement ranking algorithms to prioritize the most relevant matches based on factors such as face amount value, policy status, or claim processing timelines. The filtered and ranked policy records may be compiled into a structured output data set for forwarding to the result processing module 260.

At step 770, the verified and filtered results are forwarded to the result processing module 260. This operation is performed by the data retrieval module 250, which transmits the structured output data set compiled in step 760 to the result processing module 260 of FIG. 2 for standardization and report generation. In some embodiments, the data retrieval module 250 may transmit the structured output data set through an internal communication channel within the computing system 100, including the extracted policy data fields, verification status objects, match confidence scores, and filtering results for each policy record. The transmitted data set may also include metadata generated during the retrieval process, such as the total number of policy records returned by the external database, the number of records that passed verification, the number of records excluded by filtering criteria, and the number of refinement iterations performed. This metadata may enable the result processing module 260 to include summary statistics in the structured report generated for the user 304 of FIG. 3. In some embodiments, the data retrieval module 250 may also transmit a completion signal to the query generation module 240 indicating that the retrieval process is complete and that no further query refinement is needed.

At step 780, the retrieval transaction is logged in the auditable database. This operation is performed by the data retrieval module 250 regardless of the path taken through the sequence. In some embodiments, the data retrieval module 250 may generate a timestamped log record documenting the response received in step 710, the parsing operations performed in step 720, the verification results from step 730, the inconsistency determination from step 740, any refinement triggers at step 750, the filtering operations performed in step 760, and the forwarding action at step 770. The log record may include the unique query identifier assigned during the query generation process described with reference to FIG. 6, enabling cross-referencing with the query generation log record stored at step 690 of FIG. 6 and the database access log record stored at step 580 of FIG. 5. The log record may also include the number of policy records received, the number of records verified, the number of records excluded by filtering, and the number of refinement iterations performed. The data retrieval module 250 may transmit the log record to the database engine 204 of FIG. 2 for storage in a secure, auditable database. In some embodiments, the comprehensive logging of retrieval operations may enable reconstruction of the complete data handling chain from query transmission through result delivery, providing verifiable documentation that returned policy data was verified for integrity, filtered according to predefined criteria, and processed in compliance with data protection regulations such as the Health Insurance Portability and Accountability Act (HIPAA).

In some embodiments, the operations of steps 710 through 780 may occur automatically following transmission of a query by the database access module 230 as described with reference to FIG. 5. The automated execution of response parsing, data verification, inconsistency detection, iterative refinement, filtering, and audit logging may eliminate manual processes where funeral home providers or family members previously had to review responses from individual insurance companies, identify incomplete or inaccurate information, submit follow-up requests to the same or different insurers, and manually compile results from multiple sources into a single summary. By integrating automated parsing, verification against original query parameters, dynamic refinement through the query generation module 240, and predefined filtering criteria into a single coordinated sequence, the data retrieval module 250 may ensure that only verified, complete, and relevant policy records are forwarded for standardization and report generation, improving the reliability and usability of the information presented to the user 304.

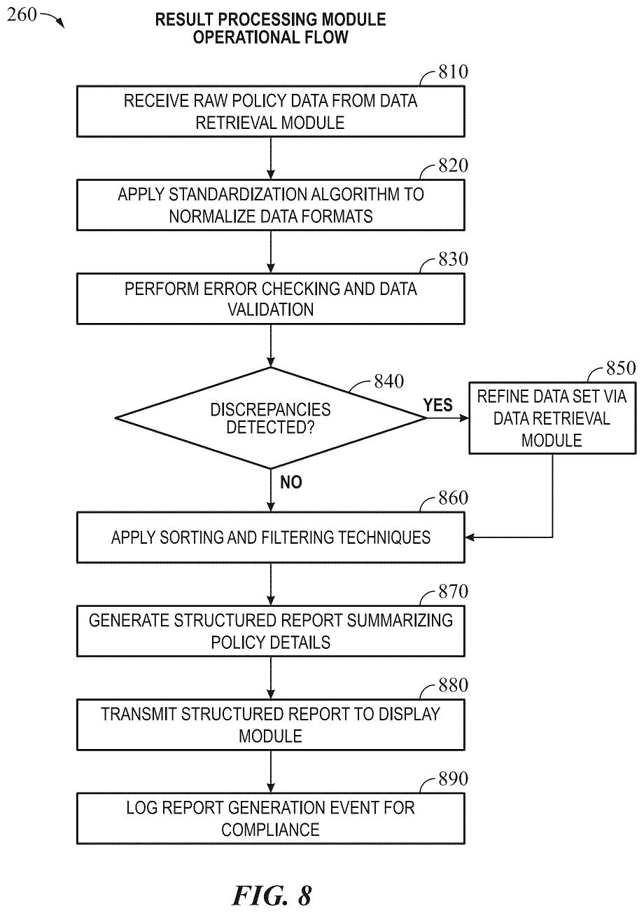

FIG. 8 is a flow diagram illustrating an exemplary operational sequence of the result processing module 260 in accordance with certain embodiments. The sequence shown may be implemented as computer-executable instructions within the application program 200 operating on computing system 100 of FIG. 2, with specific operations performed by the modules depicted therein. The result processing module 260 is configured to format, standardize, and prepare retrieved life insurance policy data for display and reporting by applying a standardization algorithm to normalize data formats and naming conventions received from multiple insurance providers.

At step 810, raw policy data is received from the data retrieval module 250. This operation may be performed by the result processing module 260, which receives the structured output data set transmitted by the data retrieval module 250 at step 770 of FIG. 7. In some embodiments, the received data set may contain verified and filtered policy records from multiple insurance carriers, each record including extracted policy data fields such as insurer names, policy numbers, face amounts, policy statuses, and beneficiary contact information. The received data set may also include metadata generated during the retrieval process, such as the total number of policy records returned, the number of records that passed verification, and the number of refinement iterations performed. The result processing module 260 may store the received data set in a temporary data structure in the memory 120 of FIG. 1 for processing in subsequent steps.

At step 820, a standardization algorithm is applied to normalize data formats. This operation is performed by the result processing module 260, which addresses the technical challenge that different insurance carriers use different data formats, naming conventions, field structures, and policy presentation methods. In some embodiments, the standardization algorithm may normalize insurer names by resolving variations such as abbreviations, trade names, and subsidiary identifiers to their canonical parent company names using a carrier name mapping table stored in the database engine 204 of FIG. 2. The algorithm may standardize policy number formats by applying carrier-specific formatting rules that convert raw policy identifiers into uniform alphanumeric representations. The algorithm may convert face amount values to uniform currency representations by detecting and resolving differences in decimal notation, currency symbols, and numeric formatting conventions across carriers. The algorithm may harmonize policy status terminology by mapping carrier-specific status codes such as “in force,” “active,” “paid-up,” or “premium-paying” to a standardized set of status categories. The algorithm may format beneficiary contact information into consistent address fields, telephone number formats, and email address representations regardless of how each carrier stores and transmits contact data. In some embodiments, the standardization algorithm may apply the normalization operations to each policy record independently, generating a standardized version of each record that conforms to a uniform data structure defined by the result processing module 260.

At step 830, error-checking and data validation are performed on the standardized output. This operation is performed by the result processing module 260, which evaluates the standardized policy records generated in step 820 to detect inconsistencies or missing fields that may have been introduced or revealed during the standardization process. In some embodiments, the result processing module 260 may verify that all required fields in each standardized policy record contain non-null values, that numeric fields such as face amounts contain valid numerical values, that date fields contain properly formatted dates, and that contact information fields contain plausible address, telephone, or email values. The result processing module 260 may flag policy records that contain detected anomalies and generate a data quality assessment for each record indicating whether the record is complete and consistent or whether it contains fields requiring further review.

At step 840, a determination is made regarding whether discrepancies are detected. This operation is performed by the result processing module 260 based on the data quality assessments generated in step 830. When the determination indicates that discrepancies are detected, such as missing required fields, implausible data values, or inconsistencies introduced during standardization, the process proceeds along the “Yes” path to step 850. When the determination indicates that no discrepancies are detected and all standardized policy records are complete and consistent, the process proceeds along the “No” path to step 860.

At step 850, the data set is refined via the data retrieval module 250. This operation is performed by the result processing module 260 when the determination in step 840 indicates that discrepancies have been detected. In some embodiments, the result processing module 260 may transmit a refinement request to the data retrieval module 250 of FIG. 2 identifying which policy records contain discrepancies and which specific data fields require supplementation or correction. The data retrieval module 250 may then evaluate whether the identified discrepancies can be resolved using data already available in the response from the external database or whether additional queries are needed as described with reference to steps 750 and 670-680 of FIG. 7 and FIG. 6, respectively. When supplementary data is obtained, the result processing module 260 may repeat the standardization operations of step 820 and the validation operations of step 830 on the updated records. In some embodiments, when discrepancies cannot be resolved through refinement, the result processing module 260 may retain the affected records with annotations indicating which fields are incomplete or unverified, enabling the user 304 of FIG. 3 to identify areas where additional follow-up with specific insurance carriers may be needed. The process then proceeds to step 860.

At step 860, sorting and filtering techniques are applied. This operation is performed by the result processing module 260, which organizes the standardized policy records according to predefined criteria. In some embodiments, the result processing module 260 may sort policy records by face amount in descending order to present the highest-value policies first, by policy status to group active policies before lapsed or matured policies, or by insurer name in alphabetical order to facilitate organized review. The result processing module 260 may apply additional filtering to exclude policy records that do not meet minimum relevance thresholds based on match confidence scores assigned by the data retrieval module 250 at step 730 of FIG. 7. In some embodiments, the sorting and filtering criteria may be configurable by administrators through settings stored in the database engine 204 of FIG. 2, enabling organizations to customize report presentation based on their operational preferences.

At step 870, a structured report summarizing policy details is generated. This operation is performed by the result processing module 260, which compiles the sorted and filtered policy records into a formatted report document. In some embodiments, the structured report may include a summary section presenting the total number of policies identified, the aggregate face amount across all identified policies, and the number of distinct insurance carriers represented in the results. The report may include a detailed section presenting each policy record with the standardized insurer name, policy number, face amount, policy status, and beneficiary contact information. In some embodiments, the report may include an annotations section identifying any policy records where data fields remain incomplete or unverified following the refinement process of step 850. The result processing module 260 may format the structured report for multiple output formats including display through the user interface, transmission via the communication module 202 of FIG. 2, or export in formats such as Portable Document Format (PDF) or JavaScript Object Notation (JSON) for integration with third-party funeral service management systems.

At step 880, the structured report is transmitted to the display module 216. This operation is performed by the result processing module 260, which forwards the generated report to the display module 216 of FIG. 2 for presentation on the user computing device 145 of FIG. 1. In some embodiments, the display module 216 may render the structured report through a web-based interface transmitted to the user computing device 145 via the network 190 of FIG. 1, presenting policy details in an organized layout. The result processing module 260 may also transmit the report to the communication module 202 for secure delivery via encrypted email or for making a downloadable document available to the user 304. In some embodiments, the notification module may send an email or Short Message Service (SMS) notification to the user 304 informing the user that life insurance policy information has been successfully retrieved and is available for review.

At step 890, the report generation event is logged for compliance. This operation is performed by the result processing module 260 regardless of the path taken through the sequence. In some embodiments, the result processing module 260 may generate a timestamped log record documenting the raw data received in step 810, the standardization operations performed in step 820, the validation results from step 830, any refinement operations performed in step 850, the sorting and filtering applied in step 860, and the report generated in step 870. The log record may include the unique query identifier enabling cross-referencing with log records generated at step 690 of FIG. 6, step 780 of FIG. 7, and step 580 of FIG. 5. The result processing module 260 may transmit the log record to the database engine 204 of FIG. 2 for storage in a secure, auditable database, ensuring that the complete data transformation chain from raw multi-carrier data to standardized report output is documented for regulatory compliance.

In some embodiments, the operations of steps 810 through 890 may occur automatically following completion of the data retrieval process described with reference to FIG. 7. By integrating automated standardization, error-checking, sorting, and report generation into a single coordinated sequence, the result processing module 260 may ensure that heterogeneous policy data from multiple insurance carriers is transformed into a uniform, structured report that is immediately interpretable and actionable for the user 304, eliminating manual processes where users previously had to reconcile inconsistent formats and terminology across responses from different insurance companies.

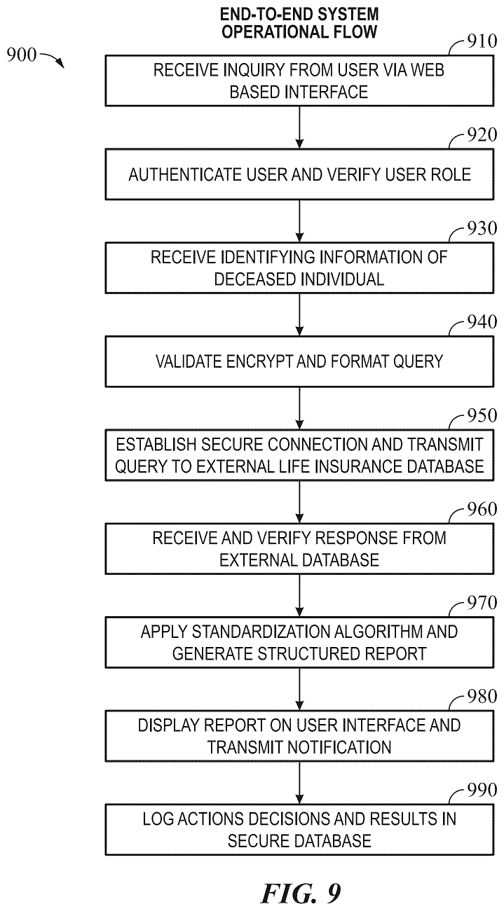

FIG. 9 is a flow diagram illustrating an exemplary end-to-end system operational flow in accordance with certain embodiments. The sequence shown may be implemented as computer-executable instructions within the application program 200 operating on computing system 100 of FIG. 2, demonstrating the integrated operation of multiple modules to process life insurance policy inquiries from initial receipt through final report delivery and audit logging.

At step 910, an inquiry is received from a user via the web-based interface. This operation may be performed by the communication module 202 and the display module 216 of FIG. 2, which receive the inquiry from the user computing device 145 of FIG. 1 via the network 190 of FIG. 1. In some embodiments, a user 304 of FIG. 3, such as a funeral home provider or a private citizen, may access the life insurance policy locator platform through a web browser or dedicated application on the user computing device 145, navigate to an inquiry submission interface, and initiate a request to search for life insurance policies associated with a deceased individual. The communication module 202 may receive the submitted inquiry and forward it to the database access module 230 of FIG. 2 to initiate the authentication process.

At step 920, the user is authenticated and the user role is verified. This operation is performed by the database access module 230, which coordinates multi-factor authentication (MFA) 303 and role-based access control (RBAC) 306 as described with reference to FIG. 3 and steps 510 through 540 of FIG. 5. In some embodiments, the database access module 230 may verify user credentials through MFA 303 requiring at least two forms of identity verification, and may confirm that the user 304 possesses an authorized role via RBAC 306 that grants permission to access the external life insurance database. When authentication and role authorization are confirmed, the system proceeds to step 930. When either verification fails, the database access module 230 may deny access and generate a lockout notification as described at step 570 of FIG. 5.

At step 930, identifying information of the deceased individual is received. This operation is performed by the query generation module 240 in coordination with the display module 216 of FIG. 2, as described at step 610 of FIG. 6. In some embodiments, the user 304 may enter the deceased individual's full name, date of birth, and Social Security number through input fields rendered on the user computing device 145. In some embodiments, the system may support automated retrieval of identifying information from a government-issued death certificate database to reduce manual input and transcription errors.

At step 940, the query is validated, encrypted, and formatted. This operation is performed by the query generation module 240, which executes the input validation, encryption, and formatting operations described at steps 620 through 650 of FIG. 6. In some embodiments, the query generation module 240 may validate the input for required fields and correct formatting, apply encryption techniques compliant with the Health Insurance Portability and Accountability Act (HIPAA), and format the query according to the technical specifications of the MIB database 302 of FIG. 3. When input validation fails, the query generation module 240 may generate automated prompts requesting the user 304 to correct identified errors before proceeding, as described at step 630 of FIG. 6.

At step 950, a secure connection is established and the query is transmitted to the external life insurance database. This operation is performed by the database access module 230, which establishes an encrypted API connection with the MIB database 302 of FIG. 3 and transmits the formatted query as described at steps 550 and 560 of FIG. 5. In some embodiments, the database access module 230 may establish the connection using Transport Layer Security (TLS) protocols, verify the identity of the MIB database 302 through certificate validation, and transmit the structured query containing encrypted identifying information via the secure API channel. The MIB database 302 may process the query by searching aggregated policy records from multiple insurance carriers and generating a response containing matching policy data.

At step 960, the response is received and verified from the external database. This operation is performed by the data retrieval module 250, which receives the response forwarded by the database access module 230, parses the response to extract policy data fields, verifies returned data against original query parameters, and applies filtering criteria as described at steps 710 through 770 of FIG. 7. In some embodiments, the data retrieval module 250 may detect inconsistencies or incomplete records and trigger dynamic query refinement through the query generation module 240 as described at steps 750 and 670-680 of FIG. 7 and FIG. 6 respectively, iteratively improving results until comprehensive, verified policy records are obtained.

At step 970, the standardization algorithm is applied and a structured report is generated. This operation is performed by the result processing module 260, which applies the standardization algorithm to normalize data formats and naming conventions from multiple insurance providers and generates a structured report as described at steps 810 through 870 of FIG. 8. In some embodiments, the result processing module 260 may normalize insurer names, standardize policy number formats, harmonize policy status terminology, and format beneficiary contact information into consistent representations. The result processing module 260 may perform error-checking and data validation on the standardized output, resolve discrepancies through coordination with the data retrieval module 250, apply sorting and filtering techniques, and compile the processed records into a structured report containing policy details including insurer names, policy numbers, face amounts, policy statuses, and beneficiary contact information.

At step 980, the report is displayed on the user interface and a notification is transmitted. This operation is performed by the display module 216, the communication module 202, and the notification module, as described at step 880 of FIG. 8. In some embodiments, the display module 216 may render the structured report through the web-based interface on the user computing device 145 via the network 190. The communication module 202 may also securely transmit the report via encrypted email or provide a downloadable document in PDF or JSON format. The notification module may send an email or SMS notification to the user 304 informing the user that life insurance policy information has been successfully retrieved and is available for review. In some embodiments, the communication module 202 may transmit the structured report to a third-party computing device 195 of FIG. 1 through the API provided by the communication module 202, enabling third-party funeral service management systems to receive and integrate policy search results into their existing workflows.

At step 990, all actions, decisions, and results are logged in a secure database. This operation is performed by the database engine 204 of FIG. 2, which consolidates audit log records generated throughout the end-to-end workflow. In some embodiments, the log records may include the database access event log from step 580 of FIG. 5, the query transaction log from step 690 of FIG. 6, the retrieval transaction log from step 780 of FIG. 7, and the report generation log from step 890 of FIG. 8. Each log record may be cross-referenced using the unique query identifier assigned during query formatting, enabling reconstruction of the complete inquiry lifecycle from user authentication through report delivery. In some embodiments, the database engine 204 may synchronize consolidated audit data with third-party systems via the network 190, enabling organizations that operate multiple platforms to maintain consistent records without manual data entry. The comprehensive logging of the complete end-to-end workflow may ensure accountability and provide a verifiable audit trail for regulatory compliance with HIPAA and other applicable data protection regulations.

In some embodiments, the operations of steps 910 through 990 represent the complete end-to-end workflow for processing life insurance policy inquiries through the life insurance policy locator platform. The integrated operation of the database access module 230, the query generation module 240, the data retrieval module 250, the result processing module 260, the communication module 202, the display module 216, the notification module, and the database engine 204 enables the system to receive inquiries, authenticate users, collect identifying information, validate and encrypt queries, establish secure database connections, transmit queries to a cross-carrier insurance industry database, receive and verify response data, standardize heterogeneous data formats from multiple insurance providers, generate structured reports, deliver results to users, and maintain comprehensive audit trails. This coordinated workflow may automate a process that previously required funeral home providers or family members to contact individual insurance companies through phone calls, emails, and independent database searches, each limited to a single carrier's records. By integrating authentication, encrypted query generation, cross-carrier database access, automated data standardization, structured report generation, and comprehensive audit logging into a unified platform, the system may reduce policy location time from weeks or months to real-time results while ensuring that sensitive policyholder information is protected throughout the entire workflow.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrases “computing device” or “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A computer-implemented system for locating life insurance policies, comprising:
a user interface configured to receive an inquiry from a funeral home provider or private citizen regarding a deceased individual's life insurance status;
a database access module configured to establish a secure connection with an external life insurance database;
a query generation module configured to format and transmit a request to the external life insurance database using identifying information provided by the user;
a data retrieval module configured to receive a response from the external life insurance database, wherein the response includes information regarding existing life insurance policies associated with the deceased individual, a policy provider, policy number, face amount, and beneficiary contact details;
a result processing module configured to format the retrieved data for display and generate a report summarizing life insurance policy details; and
a communication module configured to securely transmit the generated report to an authorized user via a web-based interface.

2. The system of claim 1, wherein the database access module is configured to authenticate users before allowing access to the external life insurance database.

3. The system of claim 1, wherein the query generation module encrypts identifying information prior to transmission to the external life insurance database to ensure data security.

4. The system of claim 1, wherein the data retrieval module filters results based on predefined criteria comprising at least one of a policy status, a claim eligibility, or an insurer-specific requirements.

5. The system of claim 1, wherein the result processing module applies a standardization algorithm to normalize data formats received from multiple insurance providers.

6. The system of claim 1, wherein the communication module provides a multi-factor authentication process before granting users access to the generated report.

7. The system of claim 1, further comprising a notification module configured to alert a user upon successful retrieval of life insurance policy information via at least one of an email or an SMS.

8. The system of claim 1, wherein the user interface allows manual input of identifying information or automated retrieval using a government-issued death certificate database.

9. The system of claim 1, wherein the system logs all inquiries and results in a secure, auditable database to ensure compliance with privacy and data protection regulations.

10. The system of claim 1, wherein the communication module includes an API allowing third-party funeral service providers to integrate a life insurance lookup functionality into their existing management systems.

11. The system of claim 1, wherein the external life insurance database comprises a Medical Information Bureau (MIB) database, and wherein the database access module transmits queries formatted according to technical specifications of the MIB database to retrieve policy-related data across multiple insurance carriers.

12. The system of claim 1, wherein the query generation module is further configured to dynamically refine subsequent queries when the data retrieval module returns partial matches or incomplete records from the external life insurance database.

13. The system of claim 1, wherein the result processing module is further configured to export the report in at least one of a PDF format or a JSON format for integration with third-party systems.

14. The system of claim 1, wherein the database access module implements load-balancing mechanisms configured to handle a plurality of concurrent queries without system delays.

15. A computer-implemented method, executed by at least one processor of a computing device, for locating life insurance policies associated with a deceased individual, the method comprising:
receiving, via the computing device, an inquiry from a user regarding the deceased individual's life insurance status, wherein the user comprises a funeral home provider or a private citizen;
establishing, via the computing device, a secure connection with an external life insurance database;
formatting, via the computing device, a request to the external life insurance database using identifying information of the deceased individual provided by the user;
transmitting, via the computing device, the request to the external life insurance database;
receiving, via the computing device, a response from the external life insurance database, wherein the response includes information regarding existing life insurance policies associated with the deceased individual, comprising a policy provider, a policy number, a face amount, and beneficiary contact details;
formatting, via the computing device, the response for display by applying a standardization algorithm to normalize data formats received from multiple insurance providers;
generating, via the computing device, a report summarizing life insurance policy details based on the formatted response; and
securely transmitting, via the computing device, the generated report to the user via a web-based interface.

16. The method of claim 15, further comprising authenticating the user via multi-factor authentication and verifying a user role via role-based access control prior to establishing the secure connection with the external life insurance database.

17. The method of claim 15, further comprising encrypting the identifying information using a secure communication protocol compliant with HIPAA prior to transmitting the request to the external life insurance database.

18. The method of claim 15, further comprising logging, via the computing device, the inquiry, the request, and the response in a secure, auditable database to generate an audit trail for regulatory compliance.

19. A software product comprising at least one non-transitory computer-readable storage medium having application instructions stored thereon, the application instructions executable by at least one processor to:
receive an inquiry from a user regarding a deceased individual's life insurance status, wherein the user comprises a funeral home provider or a private citizen;
establish a secure connection with an external life insurance database;
format and transmit a request to the external life insurance database using identifying information of the deceased individual provided by the user;
receive a response from the external life insurance database, wherein the response includes information regarding existing life insurance policies associated with the deceased individual, comprising a policy provider, a policy number, a face amount, and beneficiary contact details;
apply a standardization algorithm to normalize data formats received from multiple insurance providers contained in the response;
generate a report summarizing life insurance policy details; and
securely transmit the generated report to the user via a web-based interface.

20. The software product of claim 19, wherein the application instructions are further executable to authenticate the user via multi-factor authentication and role-based access control prior to transmitting the request, and to alert the user upon successful retrieval of life insurance policy information via at least one of an email or an SMS.
